(19) United States
(12) Patent Application Publication
(10) Pub. No.: US 2013/0335309 A1
(43) Pub. Date: Dec. 19, 2013

(54) ELECTRONIC DEVICES CONFIGURED FOR ADAPTING DISPLAY BEHAVIOR

(71) Applicants: Louis Joseph Kerofsky, Camas, WA (US); Sachin G. Deshpande, Camas, WA (US)

(72) Inventors: Louis Joseph Kerofsky, Camas, WA (US); Sachin G. Deshpande, Camas, WA (US)

(73) Assignee: Sharp Laboratories of America, Inc., Camas, WA (US)

(21) Appl. No.: 13/527,566

(22) Filed: Jun. 19, 2012

(51) Int. Cl. G09G 3/36

(52) U.S. Cl. 345/102

(57) ABSTRACT

A method for adapting display behavior on an electronic device is described. The method includes obtaining an image. The method also includes determining a backlight level based on the image. The method further includes determining a compensated image based on the image and the backlight level. The method additionally includes determining a refresh indicator based on the image. The method also includes determining pixel data based on the backlight level, the compensated image and the refresh indicator. The method further includes sending the pixel data, the refresh indicator and the backlight level.

### TECHNICAL FIELD

The present disclosure relates generally to electronic devices. More specifically, the present disclosure relates to electronic devices for adapting display behavior.

### BACKGROUND

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Many electronic devices include a display for presenting information to consumers. For example, portable electronic devices include displays for allowing digital media to be consumed at almost any location where a consumer may be. For instance a consumer may use an electronic device with a display to check email, view pictures, watch videos, see social network updates, etc. In many cases, larger displays enhance usability and enjoyment for consumers.

However, the power requirements of a display may be problematic. For portable electronic devices, the power requirement of a display may significantly limit the battery life. The increasing demand for reducing power consumption while providing the same viewing experience for the consumer may be problematic. As can be observed from this discussion, systems and methods for reducing the power consumption of a display may be beneficial.

### BRIEF DESCRIPTION OF THE DRAWINGS

FIG. 1 is a block diagram illustrating an example of an electronic device in which systems and methods for adapting display behavior may be implemented;

FIG. 2 is a flow diagram illustrating one example of a method for adapting display behavior on an electronic device;

FIG. 3 is a block diagram illustrating a more specific example of an electronic device in which systems and methods for adapting display behavior may be implemented;

FIG. 4 is a flow diagram illustrating a more specific example of a method for adapting display behavior in which the backlight control precedes the refresh control;

FIG. 5 is a block diagram illustrating another more specific example of an electronic device in which systems and methods for adapting display behavior may be implemented;

FIG. 6 is a flow diagram illustrating another more specific example of a method for adapting display behavior in which the refresh control precedes the backlight control;

FIG. 7 is a block diagram illustrating a more specific example of the refresh control;

FIG. 8 is a state diagram illustrating an adaptive state and a SELF state that the electronic device may operate according to;

FIG. 9 is a state diagram illustrating an example of operating states for adapting refresh behavior on an electronic device;

FIG. 10 is a block diagram illustrating yet another more specific example of an electronic device in which systems and methods for adapting display behavior may be implemented;

FIG. 11 is a block diagram illustrating a more specific example of a refresh control in which systems and methods for adapting refresh behavior may be implemented;

FIG. 12 is a block diagram illustrating an even more specific example of an electronic device in which systems and methods for adapting display behavior may be implemented;

FIG. 13 illustrates various components that may be utilized in an electronic device; and

FIG. 14 is a block diagram illustrating another example of an electronic device in which systems and methods for adapting display behavior may be implemented.

### DETAILED DESCRIPTION

A method for adapting display behavior on an electronic device is described. The method includes obtaining an image. The method also includes determining a backlight level based on the image. The method further includes determining a compensated image based on the image and the backlight level. The method additionally includes determining a refresh indicator based on the image. The method also includes determining pixel data based on the backlight level, the compensated image and the refresh indicator. The method further includes sending the pixel data, the refresh indicator and the backlight level.

The method may include delaying sending the backlight level based on the refresh indicator. The method may include sending the backlight level based on a fixed rate of change. Determining the backlight level may be based on the refresh indicator. The backlight level may be less than maximum. The method may include maintaining image brightness by adjusting the compensated image.

Determining the refresh indicator may be based on the backlight level and the compensated image. The refresh indicator may include a refresh flag. Determining the backlight level and determining the compensated image may occur when the refresh flag is true.

Determining the refresh indicator may include comparing the image to a stored image in a frame memory. Determining the refresh indicator may also include determining the refresh indicator based on a change in the image and the stored image. Determining the refresh indicator may be based on one or more of an adaptive refresh control, a self refresh control and a still detection control.

Determining a refresh indicator may include comparing the image to a stored image in a frame memory. Determining a refresh indicator may also include determining the refresh indicator based on a change in the image and the stored image.

An electronic device configured for adapting display behavior is also described. The electronic device includes a processor and memory in electronic communication with the processor. Executable instructions are stored in the memory. The electronic device obtains an image. The electronic device also determines a backlight level based on the image. The electronic device further determines a compensated image based on the image and the backlight level. The electronic device additionally determines a refresh indicator based on the image. The electronic device also determines pixel data based on the backlight level, the compensated image and the refresh indicator. The electronic device further sends the pixel data, the refresh indicator and the backlight level.

The systems and methods disclosed herein may be used for reducing power consumption of a host and/or a display. For example, the systems and methods disclosed herein may reduce power by combining backlight control and display refresh control. For instance, the systems and methods disclosed may reduce power consumption of an electronic system including a Liquid Crystal Display (LCD).

One known approach for reducing power consumption uses a self-refreshing display. For example, the self-refreshing display has recently been standardized in the embedded Display Port (eDP) 1.3 specification. A self-refreshing display may contain memory (e.g., video frame memory) and a control connection to a host device. The host device may command the display device to capture a frame to the memory and to continually refresh the display output from this memory while the host Graphics Processing Unit (GPU) enters a low power state (during which it does not transmit data over a main link). Thus, a self-refreshing display may allow the host device to signal to the display device to hold an image on the display. During this time, the host device may enter a low power state while the display device continues to refresh the image on the display from memory. In this design, the host device may be able to save power when static content is displayed. However, the power consumption of the self-refreshing display may not be reduced. In many cases, the self-refreshing display will refresh at a high rate, but from local memory rather than from data provided by the host device. Thus, in this known approach, the self-refreshing display may rely on control from a host.

Another known approach for reducing power consumption uses the display itself to hold the image value sent to a pixel. In this case, the display device may not need to refresh areas of the display which have not changed. For example, a low power mode for driving a display (e.g., liquid crystal display, electrophoretic display (e.g., E Ink), electrowetting display, etc.) may detect changes in the data being displayed and may only update those regions of the display where the image content has changed. However, the power consumption of the host may not be reduced in this case, since the host device may not know it is acceptable to enter a low power state. It should be noted that this known approach is internal to the display only and does not communicate with the external host.

The systems and methods disclosed herein may be used to unify backlight control and display refresh control techniques to achieve the power savings of each. In one configuration, power consumption may be reduced by using a content based backlight control system. An input image may be analyzed to select a backlight level. The backlight level may be used as a parameter to an image compensation module. The compensated pixel data and backlight level may then be sent to the display. Power reduction may be achieved when the selected backlight level is less than maximum and the image compensation module is used to maintain the brightness of the display output at reduced backlight level.

In another configuration, power consumption may be reduced by using a content based reduced refresh. For example, the input image may be compared with an image in a frame memory to determine if pixel data has changed. If the pixel data has changed and the new data needs to be written to the display, the display may be refreshed. Power savings result when the display is refreshed at an average rate less than the typical maximum value.

Various criteria may be used for selecting the refresh. For example, different states of operation may be used to efficiently refresh different types of content (that are being displayed, for example). For instance, a first state of operation may be used for efficiently refreshing a display for fast changing content and a second state of operation may be used for efficiently refreshing a display for slow changing content. In some configurations, the systems and methods disclosed herein may transition between different states of operation. In some cases, the systems and methods disclosed herein may transition between a first state of operation and a second state of operation based on each image. Some states may be signaled (e.g., signaled externally) while others are adapted automatically (within a display module, for example).

As discussed above, the systems and methods disclosed herein may enable different states of operation for efficiently refreshing a display (to reduce power consumption, for example). In some configurations, the systems and methods disclosed herein may use four display states (e.g., states of operation) and transitions between them to achieve one or more of power reduction and panel self-refresh functionality. A discussion of each display state is included below. Although four display states (e.g., the Full Refresh State, the Self Refresh State, the Motion Adaptive State and the Change Adaptive State) are discussed below, it is noted that the systems and methods disclosed herein may use two or more display states. In some configurations, the display states used may be additional and/or alternative to the four display states discussed herein.

The Full Refresh State may enable a display to operate at a maximum refresh rate. The maximum refresh rate may provide the highest motion quality at the highest power consumption. The Full Refresh State may be useful when interactive content is known to be displayed, such as when touch events are detected from a touch panel. In some configurations, entry into the Full Refresh State may be initiated by command (e.g., external command). In some configurations, exit from the Full Refresh State may be initiated either by exceeding a number of frames in the state or by command (e.g., external command). In some configurations, the Full Refresh State may exit to the Change Adaptive State.

The Self Refresh State may enable a display to refresh itself from a local memory (in the display, for example). The Self Refresh State may additionally reduce the refresh rate since the content is known to be static. For example, the refresh rate may be reduced to a very low rate (e.g., 0.5 Hertz (Hz)) for power savings within the display. In some configurations, as with eDP 1.3, the host may command the display to enter the Self Refresh State so that the host may operate in a low power state until the host commands the display to exit the Self Refresh state. In some configurations, the Self Refresh State may exit to the Change Adaptive State.

The Motion Adaptive State may monitor frame data (e.g., incoming image data) and control (e.g., adjust) the fraction of frames to display on the display based on a measure of activity in the scene. In some configurations, a frame skip number may control the operation of the display. The frame skip number may be varied (between 0 and 3, for example) depending on the measure of activity in the scene. In some configurations, the measure of activity in the scene may be based on the Sum of Absolute Difference (SAD) between two or more frames. Additionally, in some configurations, the measure of activity may be based on a moving average of past N−sum of absolute difference values between the two frames. In some configurations, the Motion Adaptive State may enable each frame to be subsampled and compared with a prior subsampled frame. In some cases, the Motion Adaptive State may exit by a command to enter Full Refresh or Self Refresh States. In other cases, the Motion Adaptive State may exit when many consecutive frames with difference at or below a threshold (zero, for example) are encountered. In this case, the Motion Adaptive State may exit to the Change Adaptive State.

The Change Adaptive State may monitor incoming data and set a refresh flag whenever a change (e.g., any change) is detected. In some cases, the Change Adaptive State may exit by a command to enter the Full Refresh State or Self Refresh State. In other cases, the Change Adaptive State may exit when several recent frames with a change are encountered. In this case, the Change Adaptive state may exit to the Motion Adaptive State.

A possible state transition may occur following each frame. A state change may be caused either by an indication (e.g., internal command, external command) or by state change logic. Following any state change, a refresh may be indicated (RefreshFlag may be set to TRUE for one frame, for example).

A state transition may result from a transition indication or from an automatic transition condition. Transition indications (e.g., internal or external commands) may have the highest priority. An indication to enter the SELF state may have higher priority than an indication to exit the SELF state. Similarly, an indication to exit the SELF state may have higher priority than an indication to enter the FULL state. Apart from the transition indications there may be at least three automatic state transitions. The MARC state may automatically transition to the CARC state when all recent frames have zero SAD. The CARC state may automatically transition to the MARC state when more than a threshold of recent frames that have had a nonzero change are detected. The FULL state may automatically transition to the CARC state when a number of recent frames that have a small SAD exceed a threshold. It is noted that a refresh may be indicated (e.g., RefreshFlag=TRUE) each time a state transition occurs.

In some configurations, the systems and methods disclosed herein may provide the functionality of eDP 1.3 panel self-refresh and may efficiently adapt (internally, for example) the display behavior of a display based on the image content.

In some configurations, the host device may provide both pixel data and optionally self-refresh indications (e.g., commands). In some configurations, a touch sensor may additionally or alternatively issue an indication for full refresh operation.

In some configurations, the systems and methods disclosed herein may reside in the host device (CPU, GPU, for example). In other configurations, the systems and methods disclosed herein may reside in the display device. In some cases, the systems and methods disclosed herein may be part of a Timing Controller (TCON) module of the display device.

It is noted that in some configurations, the systems and methods disclosed herein may directly obtain touch events from a touch sensor. In other configurations, the touch sensor may send touch events to the host device. The systems and methods disclosed herein may then obtain those touch events from the host device.

The systems and methods disclosed herein may provide one or more benefits that are described as follows. In some configurations, the possible refresh states may be limited to the MARC state and the SELF state. In these configurations, the frame memory may be powered only for the SELF state. Therefore, these configurations may reduce power consumption and complexity. In other configurations, the possible refresh states may be limited to the CARC state and the SELF state. These configurations may be beneficial because no SAD calculation logic or buffers may be needed. Therefore, these configurations may reduce complexity and power consumption.

In some configurations, the systems and methods disclosed herein may be based on SAD only. For instance, the refresh rates may be controlled based on SAD only. In other configurations, the systems and methods disclosed herein may be based on frame change data only. In yet other configurations, the systems and methods disclosed herein may be based on a combination (e.g., mixture) of SAD and frame change data. For example, in some configurations, the MARC state may be based on SAD while the CARC state may be based on frame change data. Each of these configurations may be beneficial for reducing power consumption and complexity.

As described above, the systems and methods disclosed herein may be used to unify the backlight control and refresh control techniques described above to achieve the power savings of each. In one configuration, the backlight control method may precede the reduced refresh control. In another configuration, the reduced refresh control may precede the backlight control. In each case, additional elements may be added to allow the backlight control and the reduced refresh modules to operate together without introducing artifacts on the display.

In a configuration where the refresh control precedes the backlight control, the refresh control module may operate on the original image data. The refresh control module may then supply a refresh indicator and pixel data to the backlight control module. In one configuration, the refresh indicator may be a refresh flag. When the refresh flag is true, data may be written to the display and the backlight control module may operate as usual. When the display is not being refreshed, the backlight control module may hold its output value and the image compensation module may remain idle because no pixel data is supplied by the refresh control module. In another configuration, a frame rate value may be set for the display based on the refresh control module. For example, the refresh indicator may additionally or alternatively include a frame rate value. The display may accordingly refresh (e.g., refresh the display) at the set frame rate value.

In another configuration, the backlight control precedes the refresh control. In this configuration, the backlight control module may operate first on the input image. Following backlight level selection and image compensation, the compensated image data may be sent to the refresh control module. It is possible that the compensated image data may change even when the input is constant if the backlight level changes. For example, the backlight level may change even when the input image is constant due to temporal filtering of the backlight signal within the backlight level determination module. The refresh control module may operate on the compensated image data by determining a value for the refresh indicator. For example, when the refresh indicator is true, pixel data may be written to the display panel and the backlight level may be updated. When the refresh flag is false, the pixel data may not be written to the display and the backlight level may remain unchanged. The backlight level may be delayed to account for the processing delay within the refresh control module. An alternative to using this delay is to limit the rate of change of the backlight level in the backlight control module. For example, a backlight level may be based on a fixed rate of change. The backlight level based on the fixed rate of change may be sent. In another configuration, the refresh control module may set the refresh indicator for the current frame by keeping track of the selected backlight level for the current frame and the backlight level for one or more previous frames.

In some configurations, no specific video buffer may be needed. Instead, subsamples from the frame buffer may be used as needed. This may be beneficial because even though the frame memory may not be powered down, no additional video memory may be needed and the processing requirements for motion detection may be reduced by operating at the subsampled resolution. Therefore, these configurations may allow for decreased complexity and reduced power consumption.

In one example, the systems and methods disclosed herein may be located within the electronic device itself. In this example, the systems and methods disclosed herein may combine external commands provided outside of the electronic device with internal display refresh rate control.

In another example, the systems and methods disclosed herein may measure the motion activity to determine periods when the refresh rate may be reduced even though the image data is changed slightly. Adjusting a refresh rate based on a measure of motion activity may be combined with the self refresh functionality discussed previously. It is noted that in some configurations, the systems and methods disclosed herein may utilize two or more states and transitions between those states to adapt the refresh behavior (e.g., refresh rates). In some configurations, the systems and methods disclosed herein may monitor image content to control the refresh characteristics of a display device.

In another example, the systems and methods disclosed herein may provide visibility into the display module. For example, the systems and methods disclosed herein may regulate panel addressing.

In yet another example, the systems and methods disclosed herein may be located within the display itself. In some cases, the display device that includes the systems and methods disclosed herein may not be driven regularly and may not be a bi-stable or self-refreshing display. However, the systems and methods disclosed herein may adapt the refresh behavior of the display device. For example, if the display device (with a significant hold time, for example) may hold an image for a finite time (e.g., 2 seconds), then the systems and methods disclosed herein may refresh the display at a moderate refresh rate even in the absence of changes to accommodate the hold time of the display.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

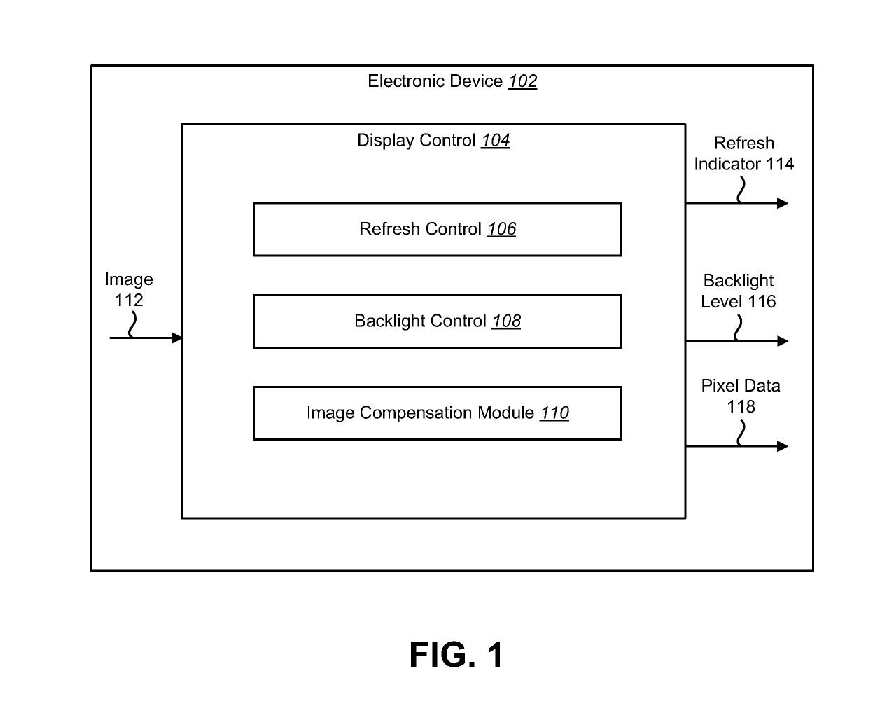

FIG. 1 is a block diagram illustrating an example of an electronic device 102 in which systems and methods for adapting display behavior may be implemented. The electronic device 102 may include a display control 104. The display control 104 may include a refresh control 106, a backlight control 108 and an image compensation module 110. As used herein, a “module” may be implemented in hardware (e.g., circuitry), software or a combination of both. For example, the image compensation module 110 may be implemented in hardware, software or a combination of both. Note that the electronic device 102 may be integrated with a display (not shown in FIG. 1), or the display may be separate from the electronic device 102.

The display control 104 may obtain one or more images 112. In some cases, the one or more images 112 may come as a continuous stream. In other cases, the one or more images 112 may come at irregular intervals. In some cases, the images 112 may be obtained from an external source (e.g., a host device). In other cases, the images 112 may be obtained from memory located within the electronic device 102. In some cases, the image 112 may be a frame from a video sequence. In other cases, the image 112 may be a still image (e.g., a photograph). In yet another case, the image 112 may be a display output from the host device (e.g., a graphical user interface (GUI)).

The refresh control 106 may determine a refresh indicator 114 based on the image 112 obtained by the display control 104. For example, the obtained image 112 may be compared with an image in a frame memory to determine if the image has changed and if new pixel data may need to be written to the display (e.g., the display may need to be refreshed). When a refresh is needed, the refresh control may issue a refresh indicator 114 that may signify that the refresh may proceed. Various techniques may be utilized by the refresh control 106 to adapt refresh behavior. These techniques may include operating according to an adaptive state (e.g., MARC, CARC, etc.), a Self Refresh (SELF) state or a state determination module based on the content of the images 112. These techniques will be discussed in more detail below. One benefit of adapting display behavior through the refresh control 106 is that power savings may result when the display is refreshed at a rate less than the maximum refresh rate.

The backlight control 108 may analyze input data (e.g., an image 112) to determine a backlight level 116 for the display. For example, the backlight control 108 may analyze the image 112 obtained by the display control 104 in order to determine the correct display backlight brightness for the image 112. The backlight level 116 may be a signal that corresponds to the settings of the display's backlight. One benefit of adapting display behavior through the backlight control 108 is that power savings may result when the display backlight operates at a level less than maximum.

The image compensation module 110 may adjust the image 112 based on the backlight level 116 determined by the backlight control 108. For example, the image compensation module 110 may adjust the image as the backlight level 116 may change in order to accurately reproduce the displayed image. Note that the compensated image may change even when an obtained image 112 is constant due to changes in the backlight level 116. Additionally, the backlight level 116 and the compensated image may also change when an obtained image 112 is constant due to temporal filtering of the backlight signal within the backlight control 108. In some configurations, the image compensation module 110 may be integrated with backlight control 108. As described above, one benefit of backlight control is the power savings that results when the backlight level 116 is less than maximum. The image compensation module 110 may facilitate this beneficial behavior by adjusting the image 112 to be displayed with a lower backlight level 116. For example, image brightness may be maintained by adjusting the compensated image (even when the backlight level is less than maximum, for instance).

The refresh control 106, the backlight control 108 and the image compensation module 110 may be connected such that the output of one or more may be the input of the other. In one configuration, the results of the backlight control 108 and the image compensation module 110 may become the input of the refresh control 106. For example, the backlight control 108 may determine a backlight level 116 and the image compensation module 110 may determine a compensated image, which may then be input into the refresh control 106. In another configuration, the results of the refresh control 106 may become the input of the backlight control 108 and the image compensation module 110. For example, after the refresh control 106 may have determined a refresh indicator 114, the backlight control 108 may determine the backlight level 116 and the image compensation module 110 may determine a compensated image. Various configurations for the refresh control 106, the backlight control 108 and the image compensation module 110 will be discussed in more detail below.

The display control 104 may determine pixel data 118 based on the results of the refresh control 106, the backlight control 108 and the image compensation module 110. For example, the pixel data 118 may be the compensated image determined by the image compensation module 110. Additionally, the pixel data 118 may be based on the refresh indicator 114 determined by the refresh control 106. For example, the electronic device 102 may wait to send the pixel data 118 until a refresh indicator 114 instructs the display to refresh.

The refresh indicator 114, the backlight level 116 and the pixel data 118 may be sent from the display control 104. For example, the refresh indicator 114 may be sent to an address control on the display. The pixel data 118 may also be sent to the display, which may be used by the display to display an image. The backlight level 116 may be sent to a backlight module on the display in order to adjust the brightness of the display's backlight.

It should be noted that one or more of the elements or parts thereof included in the electronic device 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

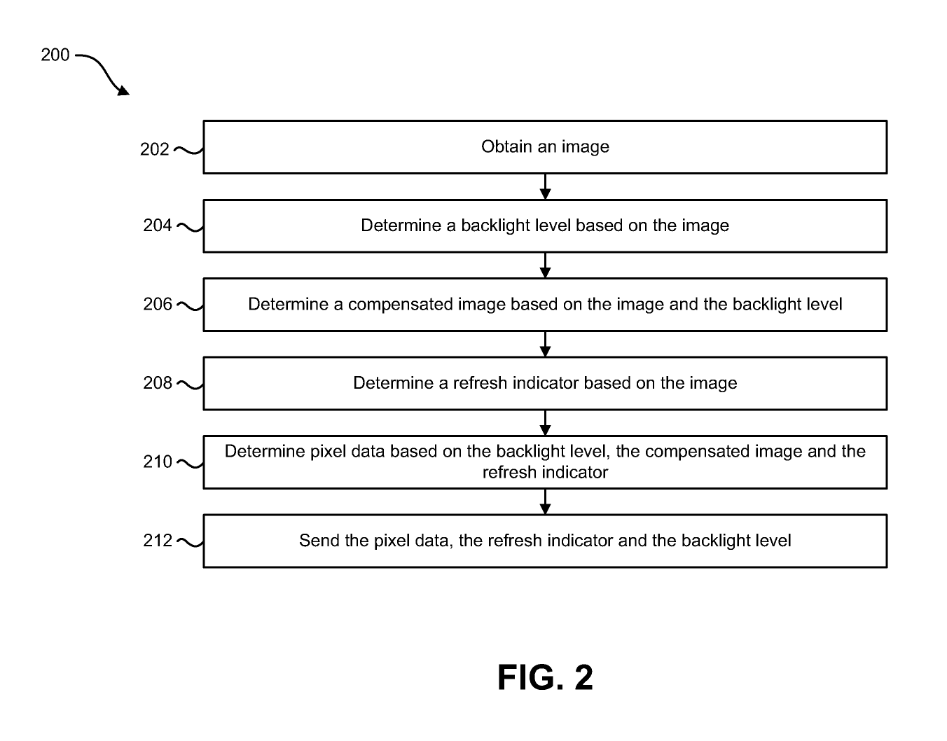

FIG. 2 is a flow diagram illustrating one example of a method 200 for adapting display behavior on an electronic device 102. An electronic device 102 may obtain 202 an image 112. For example, the image 112 may be obtained 202 from a host device or the image 112 may be obtained from a local memory (e.g., frame memory) located within the electronic device 102. In some cases, the image 112 may be obtained as a continuous stream (e.g., multiple frames of a video sequence). In other cases, the image 112 may be obtained intermittently. In yet another case, subsequent images 112 may be the same image (e.g., a still image).

The electronic device 102 may determine 204 a backlight level 116 based on the image 112. For example, the backlight control 108 may analyze the image 112 obtained by the electronic device 102. After analyzing the image 112, the backlight control 108 may determine 204 the correct display backlight brightness for the image 112. For example, the image 112 may not require the backlight to operate at a maximum level (e.g., when the image 112 is dark), and the backlight control 108 may determine 204 that a backlight level 116 is less than maximum. In some cases, however, the backlight control 108 may determine 204 that the backlight level 116 may be maximum (e.g., when the image 112 is bright).

The electronic device 102 may determine 206 a compensated image based on the image 112 and the backlight level 116. For example, the image compensation module 110 may compare the image 112 and backlight level 116 to determine 206 a compensated image that accurately represents the image 112 at a previously determined 204 backlight level 116. For instance, the electronic device 102 may reduce power consumption by reducing the backlight level 116 and compensating for the backlight reduction by adjusting the image 112.

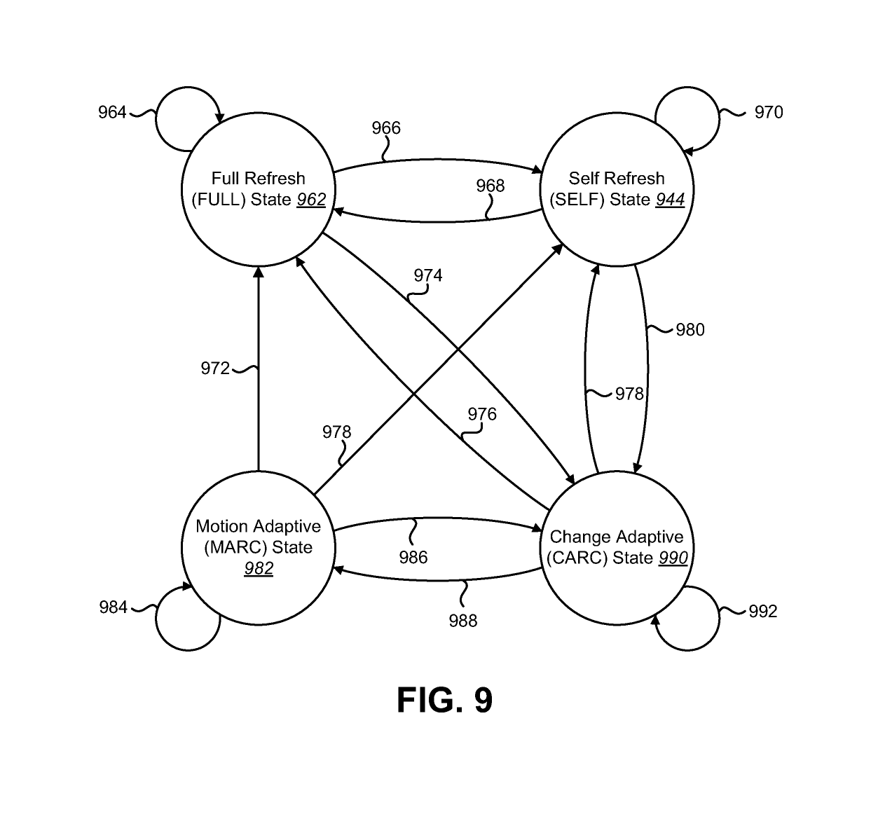

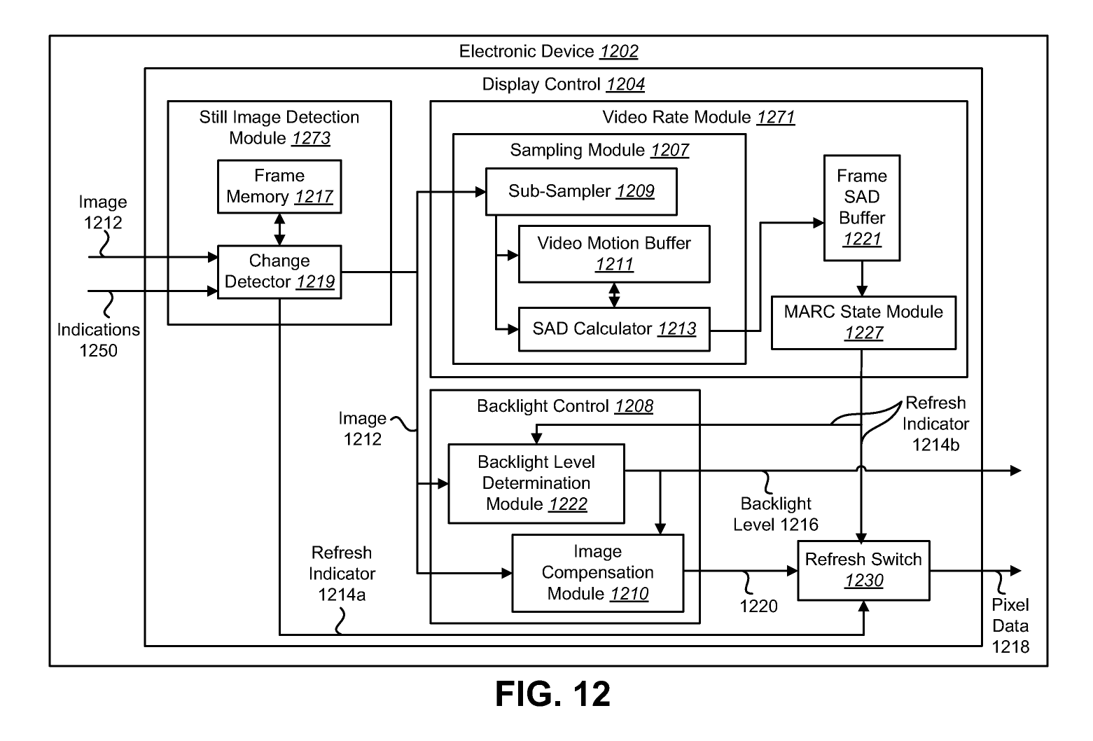

The electronic device 102 may determine 208 a refresh indicator 114 based on the image 112. For example, the electronic device 102 may determine 208 a refresh indicator 114 according to various states of operation. For instance, an adaptive state adapts a refresh rate for a display based on at least one image 112. Examples of the adaptive state include a change adaptive state and a motion adaptive state. More detail is given below on the change adaptive and the motion adaptive states (as discussed below in connection with FIG. 9, for example). In some configurations, operating according to an adaptive state may include adapting the refresh rate based on a difference between two or more images 112. For example, when operating according to the adaptive state, the electronic device 102 may indicate a refresh each time a difference between two images 112 exceeds a threshold (e.g., 0, 10%, 20%, etc.). Alternatively, the electronic device 102 may operate according to a self refresh state based on a first self refresh state indication. For example, the electronic device 102 may transition from the adaptive state to the SELF state immediately following the image 112 during which the self refresh state indication is received (e.g., upon obtaining or receiving a self refresh state indication). The electronic device 102 may also operate according to full refresh state, in which the electronic device 102 may provide a refresh indicator 114 to the display to refresh itself at least for each image obtained. In some examples, determining 208 the refresh indicator is based on one or more of adaptive refresh control, self refresh control and still detection control. More detail regarding adaptive refresh control, self refresh control and still detection control is described in connection with FIG. 12 below.

The electronic device 102 may determine 210 pixel data 118 based on the backlight level 116, the compensated image and the refresh indicator 114. For example, the pixel data 118 may be based on the compensated image that was determined 206 by the image compensation module 110. In one configuration, the refresh indicator 114 may control when the image compensation module 110 determines the compensated image. In one configuration, the image 112 may not pass to the image compensation module 110 until a refresh indicator 114 is issued that indicates a refresh.

The electronic device 102 may send 212 the pixel data 118, the refresh indicator 114 and the backlight level 116. In one configuration, the refresh indicator 114 and the backlight level 116 may be sent 212 immediately upon determination 204, 208. In another configuration, the electronic device 102 may delay sending 212 the backlight level 116 to account for a processing delay within the refresh control 106. Alternatively, the electronic device 102 may limit the rate at which the backlight level 116 is sent 212. The sending 212 of the pixel data 118 may be controlled by the refresh indicator 114. For instance, the pixel data 118 may not be sent until a refresh indicator 114 is issued that indicates a refresh.

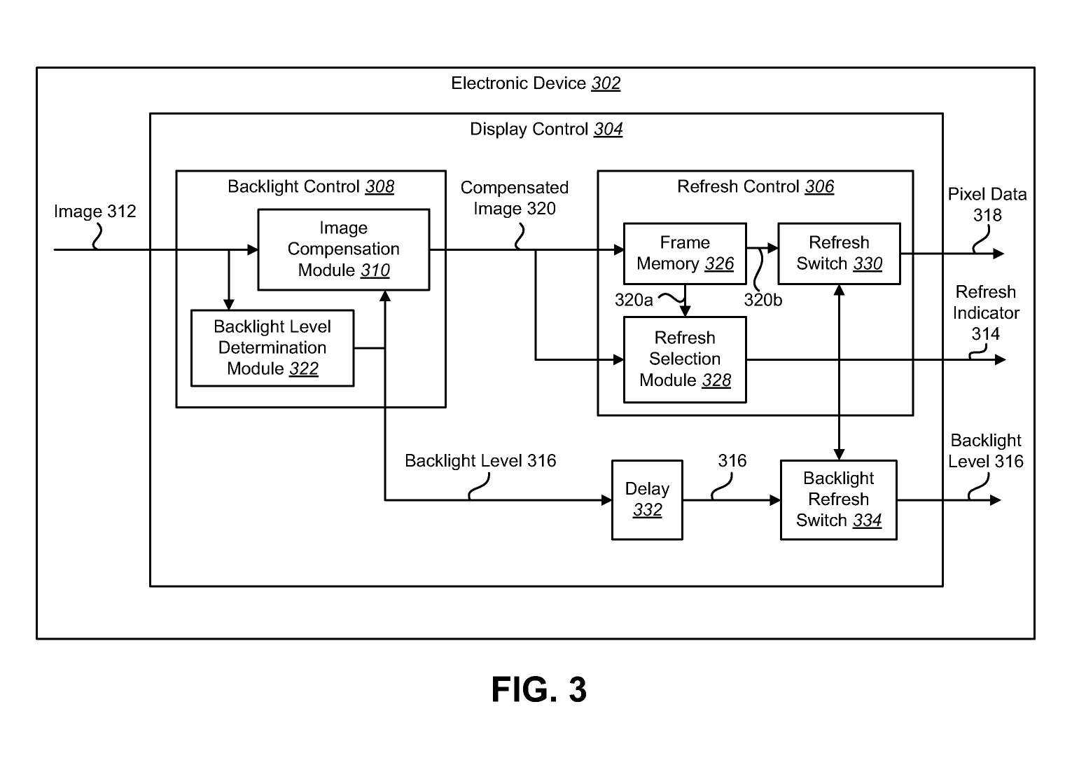

FIG. 3 is a block diagram illustrating a more specific example of an electronic device 302 in which systems and methods for adapting display behavior may be implemented. In the configuration depicted in FIG. 3, the backlight control 308 precedes the refresh control 306. The electronic device 302 may include a display control 304. The display control 304 may include a backlight control 308 and a refresh control 306. The backlight control 308 may be similar to the backlight control 108 and the refresh control 306 may be similar to the refresh control 106 described previously with respect to FIG. 1. The display control 304 may obtain an image 312 that may be an input to the backlight control 308.

The backlight control 308 may include a backlight level determination module 322. Additionally, the backlight control 308 may include an image compensation module 310. The backlight level determination module 322 may analyze the image 312 to determine a backlight level 316. The image compensation module 310 may obtain the image 312 and may adjust the image using the backlight level 316 to determine a compensated image 320. After backlight level selection and image compensation, the compensated image 320 may be sent to the refresh control 306.

The refresh control 306 may include a frame memory 326, a refresh selection module 328 and a refresh switch 330. The refresh control 306 may determine a refresh indicator 314 based on the compensated image 320. For example, the compensated image 320 may be stored in a frame memory 326. The refresh selection module 328 may compare the compensated image 320 to prior compensated images 320a stored in the frame memory 326 in order to determine a refresh indicator 314 based on whether a refresh may be needed. The techniques that may be used by the refresh selection module 328 to determine the refresh indicator 314 will be discussed in more detail below. A refresh switch 330 may output the compensated image 320b based on the refresh indicator 314. For instance, when the refresh indicator 314 indicates a refresh (e.g., if the refresh flag is true), the refresh switch 330 may permit the compensated image 320b to pass as pixel data 318. Otherwise, the refresh switch 330 may prevent output of the pixel data 318. In some configurations, the refresh switch 330 may be a hardware switch (e.g., for switching between bit level signals, electrical signals, etc.). In other configurations, the refresh switch 330 may be a software switch (e.g., for switching between processes, lines of code, algorithms, etc.).

The display control 304 may include a delay 332 that may account for the processing delay within the refresh control 306. For example, the refresh control 306 may require more time to complete its operations than the backlight control 308. Because the refresh control 306 follows the backlight control 308 in the configuration shown in FIG. 3, to ensure that the correct backlight level 316 is associated with the corresponding pixel data 318, the display control 304 may use the delay 332. Additionally, the display control 304 may include a backlight refresh switch 334 that may respond to the refresh indicator 314. The delay 332 may be timed such that the backlight level 316 may arrive at the backlight refresh switch 334 when the corresponding compensated image 320b may arrive at the refresh switch 330. In another configuration, an alternative to the delay 332 and the backlight refresh switch 334 may be to regulate the rate at which the backlight level 316 is sent from the backlight control 308. It is noted that in this configuration the backlight level 316 may change when the pixel data 318 changes.

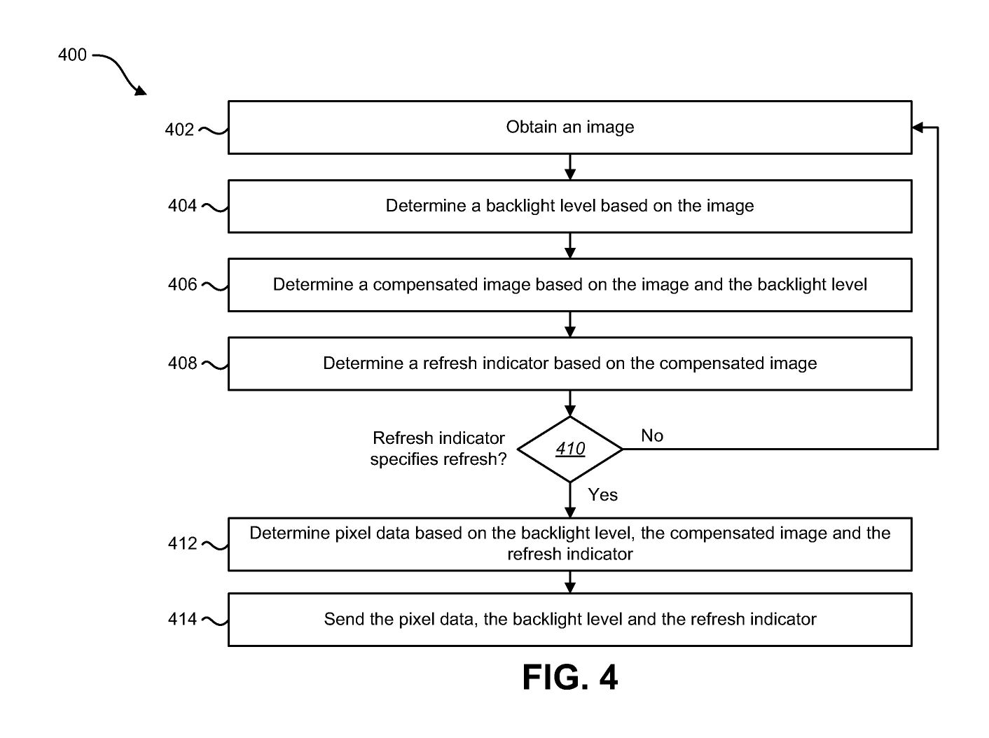

FIG. 4 is a flow diagram illustrating a more specific example of a method 400 for adapting display behavior in which the backlight control 108 precedes the refresh control 106. The electronic device 102 may obtain 402 an image 112. For example, the electronic device 102 may obtain 402 an image as described above in connection with FIG. 2. The electronic device 102 may also determine 404 a backlight level 116 based on the image 112. For example, the electronic device 102 may determine 404 a backlight level 116 based on the image 112 as described above in connection with FIG. 2. The electronic device 102 may additionally determine 406 a compensated image based on the image 112 and the backlight level 116. For example, the electronic device 102 may determine 406 a compensated image as described above in connection with FIG. 2.

The electronic device 102 may determine 408 a refresh indicator 114 based on the compensated image. For example, the electronic device 102 may store the compensated image in a frame memory 326. The electronic device 102 may compare the compensated image to prior compensated images 120 stored in the frame memory 326 in order to determine whether a refresh may be needed. If a refresh is needed, the electronic device 102 may issue a refresh indicator 114 that may indicate or specify a display refresh. The techniques that may be used by electronic device 102 to determine whether a refresh may be needed will be discussed in more detail below.

The electronic device 102 may determine 410 whether the refresh indicator 114 specifies a refresh (e.g., display refresh). If the refresh indicator 114 specifies a refresh, then the electronic device 102 may determine 412 pixel data 118 based on the backlight level 116, the compensated image and the refresh indicator 114. If the refresh indicator 114 does not specify a refresh, then the electronic device 102 may loop back to obtaining 402 an image. In this case, for example, a subsequent or different image may be analyzed.

The electronic device 102 may determine 412 pixel data 118 based on the backlight level 116, the compensated image and the refresh indicator 114. The electronic device 102 may also send 414 the pixel data 118, the refresh indicator 114 and the backlight level 116. This may be accomplished as described above in FIG. 2.

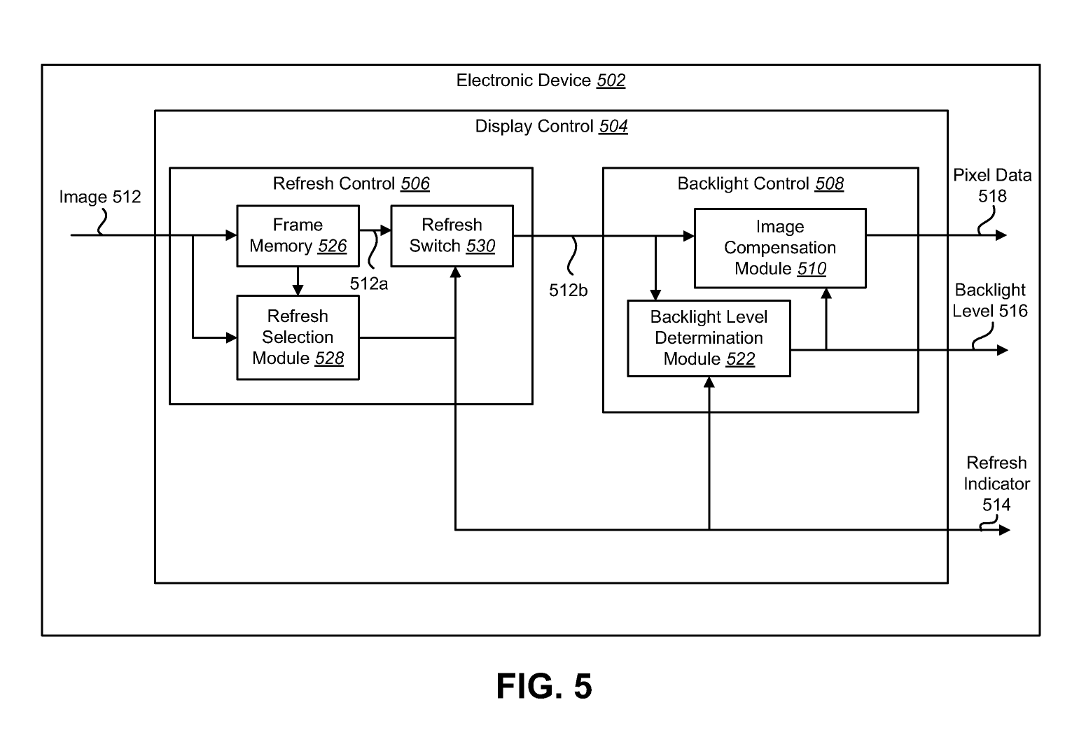

FIG. 5 is a block diagram illustrating another more specific example of an electronic device 502 in which systems and methods for adapting display behavior may be implemented. In the configuration depicted in FIG. 5, the refresh control 506 precedes the backlight control 508. As described above, the electronic device 502 may include a display control 504. The display control 504 may include a refresh control 506 and a backlight control 508. The backlight control 508 may be similar to the backlight control 108 and the refresh control 506 may be similar to the refresh control 106 described previously with respect to FIG. 1. The display control 504 may obtain an image 512 that may be an input to the refresh control 506.

The refresh control 506 may include a frame memory 526, a refresh selection module 528 and a refresh switch 530. The refresh control 506 may determine a refresh indicator 514 based on the image 512 obtained by the display control 504. For example, the refresh selection module 528 may compare the image 512 to prior images 512 stored in the frame memory 526 in order to detect changes and determine whether a refresh may be needed. If a refresh is needed, the refresh selection module 528 may issue a refresh indicator 514 that may indicate a display refresh. The refresh indicator 514 may be sent to a display (e.g., an integrated display panel or a separate display). The techniques that may be used by the refresh selection module 528 to determine the refresh indicator 514 will be discussed in more detail below. A refresh switch 530 may respond to the refresh indicator 514. For instance, when the refresh indicator 514 indicates a refresh, the refresh switch 530 may permit the image 512a to pass to the backlight control 508.

The backlight control 508 may include a backlight level determination module 522. Additionally, the backlight control 508 may include an image compensation module 510. The backlight level determination module 522 may analyze the image 512b to determine a backlight level 516. The image compensation module 510 may obtain the image 512b and may determine a compensated image (not shown) using the backlight level 516. After backlight level selection and image compensation, the compensated image may be sent to the display as pixel data 518. The backlight level 516 may also be sent to the display. It is noted that in this configuration, when the display is not being refreshed, the backlight level determination module 522 may hold the output value of the backlight level 516 and the image compensation module 510 may remain idle because no image data is supplied by the refresh control 506. However, when the refresh indicator 514 indicates that a refresh may proceed, the backlight control 508 may operate and pixel data 518 may be sent to the display.

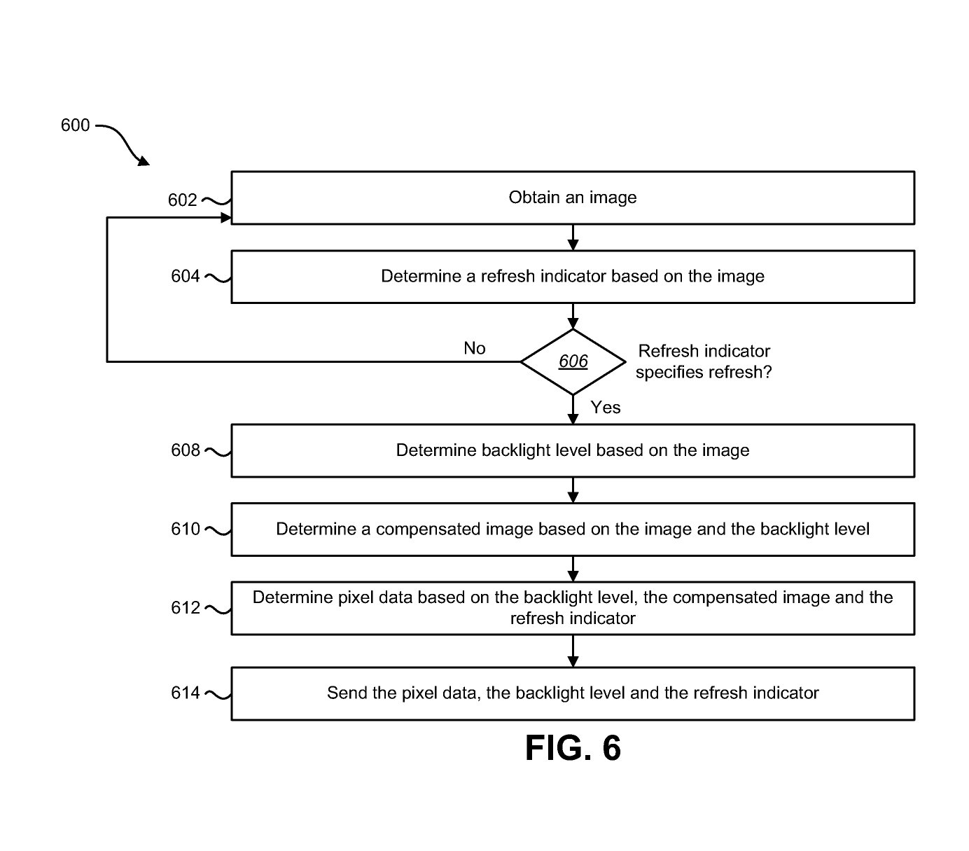

FIG. 6 is a flow diagram illustrating another more specific example of a method 600 for adapting display behavior in which the refresh control 106 precedes the backlight control 108. The electronic device 102 may obtain 602 an image 112. This may be accomplished as described above in FIG. 2.

The electronic device 102 may determine 604 a refresh indicator 114 based on the image 112. For example, the electronic device 102 may store the image 112 in a frame memory 526. The electronic device 102 may compare the image 112 to prior images 112 stored in the frame memory 526 in order to determine whether a refresh may be needed. If a refresh is needed, the electronic device 102 may issue a refresh indicator 114 that may indicate or specify a display refresh. The techniques that may be used by electronic device 102 to determine whether a refresh may be needed will be discussed in more detail below.

The electronic device 102 may determine 606 whether the refresh indicator specifies a refresh (e.g., display refresh). If the refresh indicator does not specify a refresh, then the electronic device 102 may loop back to obtaining 602 an image 112. If the refresh indicator specifies a refresh, then the electronic device 102 may determine 608 the backlight level 116 based on the image 112. In other words, determining 608 the backlight level 116 may be based on the refresh indicator (e.g., the backlight level 116 may be determined 608 when specified by the refresh indicator). Determining 608 the backlight level 116 based on the image 112 may be accomplished as described above in FIG. 2.

The electronic device 102 may determine 610 a compensated image based on the image 112 and the backlight level 116. For example, the electronic device 102 may determine 610 a compensated image based on the image 112 and the backlight level 116 as described in connection with FIG. 2. The electronic device 102 may also determine 612 pixel data 118 based on the backlight level 116, the compensated image and the refresh indicator 114. For example, the electronic device 102 may determine 612 pixel data 118 based on the backlight level 116, the compensated image and the refresh indicator 114 as described in connection with FIG. 2. The electronic device 102 may send 614 the pixel data 118, the refresh indicator 114 and the backlight level 116. For example, the electronic device 102 may send 614 the pixel data 118, the refresh indicator 114 and the backlight level 116 as described in connection with FIG. 2.

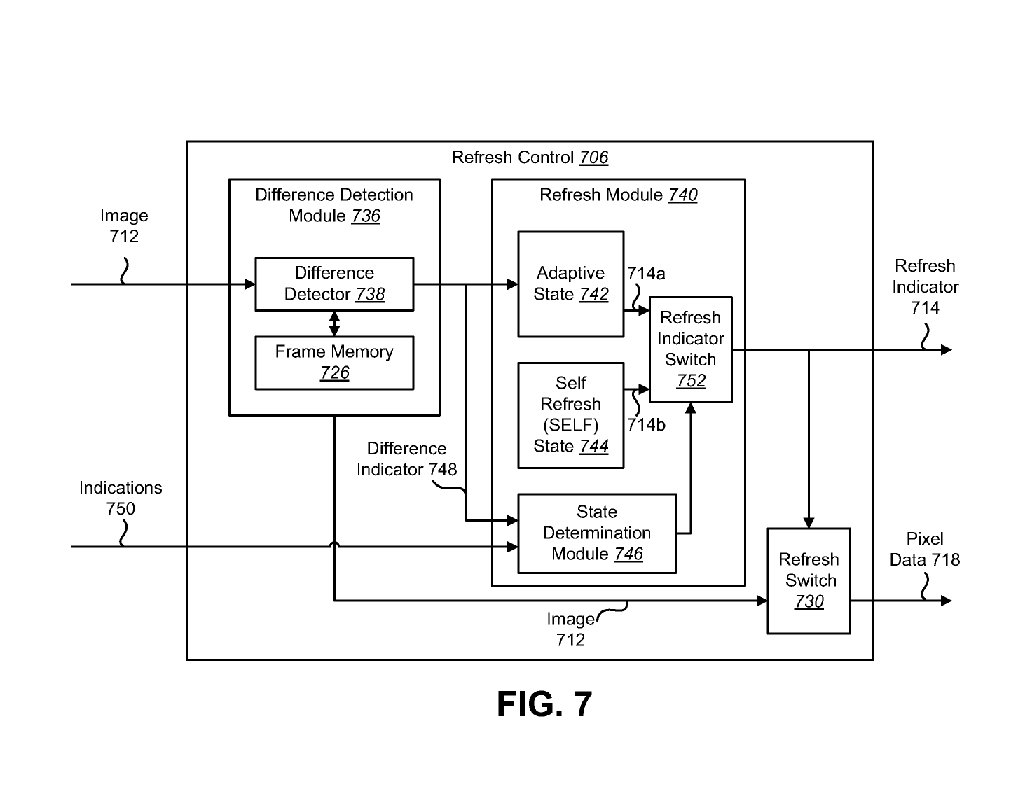

FIG. 7 is a block diagram illustrating a more specific example of the refresh control 706. The refresh control 706 may include a difference detection module 736 and a refresh module 740. The difference detection module 736 may include a difference detector 738 and a frame memory 726 for detecting differences between two or more images 712. The refresh module 740 may include an adaptive state 742, a Self Refresh (SELF) state 744 and a state determination module 746 for adapting refreshing behavior based on the content of the images 712. Examples of the adaptive state include the Change Adaptive State and the Motion Adaptive State described above. Each of the elements included within the refresh control 706 (e.g., the difference detection module 736 and difference detector 738) may be implemented in hardware, software or a combination of both.

The difference detector 738 may obtain one or more images 712 (e.g., incoming frames) as an input and may send a difference indicator 748 based on the one or more images 712 as an output. In some cases, the one or more images 712 may come as a continuous stream. In other cases, the one or more images 712 may come at irregular intervals. As described above, the images 712 may be the original obtained images 112, or they may be compensated images 320 obtained from the backlight control 308. The difference detector 738 may detect any difference between a prior stored frame (stored in the frame memory 726, for example) and a subsequent frame. In some configurations, full frames (e.g., images 712) with all the pixels in the frames may be stored in the frame memory 726. In another configuration, sub-sampled frames (e.g., images 712) with fewer pixels than a full frame may be stored in the frame memory 726. In yet another configuration, compressed frames (e.g., images 712) corresponding to full frames may be stored in the frame memory 726. The compression used may be lossless compression or lossy compression. For instance, the change or difference detection and/or SAD calculations described herein may be applied to compressed frames in some configurations.

In one example, the difference detector 738 may store a first image 712 in the frame memory 726 (after comparing it with a previous image 712, for example). The difference detector 738 may then obtain a second (e.g., subsequent) image 712 and detect any differences between the second image 712 and the first image 712. If a difference exists between a first image 712 and a second image 712, then the difference detector 738 may indicate (via difference indicator 748, for example) that a difference has occurred. If a difference does not exist between the first image 712 and the second image 712 then the difference detector 738 may indicate (via difference indicator 748, for example) that no difference has occurred. The adaptive state 742 and the state determination module 746 may obtain the difference indicator 748.

The difference detection module 736 may output the image 712 to a refresh switch 730. The refresh switch 730 may output pixel data 718 based on whether the refresh indicator 714 indicates a display refresh. Examples of pixel data 718 include full frames and sub-sampled frames. In some cases, pixel data 718 may be provided from the frame memory 726. In other cases, pixel data 718 may be a passed through version of the images 712. For example, during a SELF state 744 (signaled by a host to the electronic device 102 (e.g., display module), for instance) the pixel data 718 may be provided by the frame memory 726 (while the host stops providing the images 712, for example). During the adaptive state 742, the pixel data 718 may be the images 712 (while a host is providing the images 712, for example).

The refresh module 740 may adapt refresh behavior based on two or more operating states. For example (as illustrated in FIG. 7), the refresh module 740 may operate according to the adaptive state 742 or may operate according to the SELF state 744. Each state may output a refresh indicator 714a-b for indicating refresh behavior based on the state. In some configurations, the refresh module 740 may additionally include a refresh indicator switch 752 for outputting the refresh indicator 714 of the current operating state. For example, if the refresh module 740 is operating according to the adaptive state 742, then the refresh indicator switch 752 will output any refresh indicators 714 indicated by the adaptive state 742. In some configurations, the refresh indicator switch 752 may be a hardware switch (e.g., for switching between bit level signals, electrical signals, etc.). In other configurations, the refresh indicator switch 752 may be a software switch (e.g., for switching between processes, lines of code, algorithms, etc.). In some configurations, the refresh indicator switch 752 may be controlled by the state determination module 746.

The refresh module 740 may obtain a difference indicator 748 and one or more indications 750 as inputs and may output the appropriate refresh indicator 714 based on an operating state (e.g., adaptive state 742, SELF state 744), the difference indicator 748 and the one or more indications 750.

The adaptive state 742 may obtain the difference indicator 748 as an input and may adapt refresh behavior (via a refresh indicator 714, for example) based on the difference indicator 748. For instance, the adaptive state 742 may indicate a higher refresh rate (e.g., 50 Hz) when the difference indicator 748 indicates significant differences between images 712 and may indicate a lower refresh rate (e.g., 10 Hz) when the difference indicator 748 indicates insignificant differences between images 712. Additionally or alternatively, the adaptive state 742 may only indicate a refresh (via the refresh indicator 714, for example) when a difference between images 712 is detected. The SELF state 744 may adapt refresh behavior (via the refresh indicator 714, for example) based on a static frame (stored in local memory, for example) and the hold time of a display. The refresh flag described above may be one example of the refresh indicator 714.

The state determination module 746 may determine which state the refresh module 740 should be operating according to. The state determination module 746 may obtain the difference indicator 748 and the one or more indications 750 as inputs for determining which state in which to operate. For example, the state determination module 746 may determine that the refresh module 740 should operate according to the SELF state 744 based on an indication 750 (e.g., an internal or external command) to operate in the SELF state 744. As another example, the state determination module 746 may determine that the refresh module 740 should operate according to the adaptive state 742 based on differences indicated by the difference indicator 748.

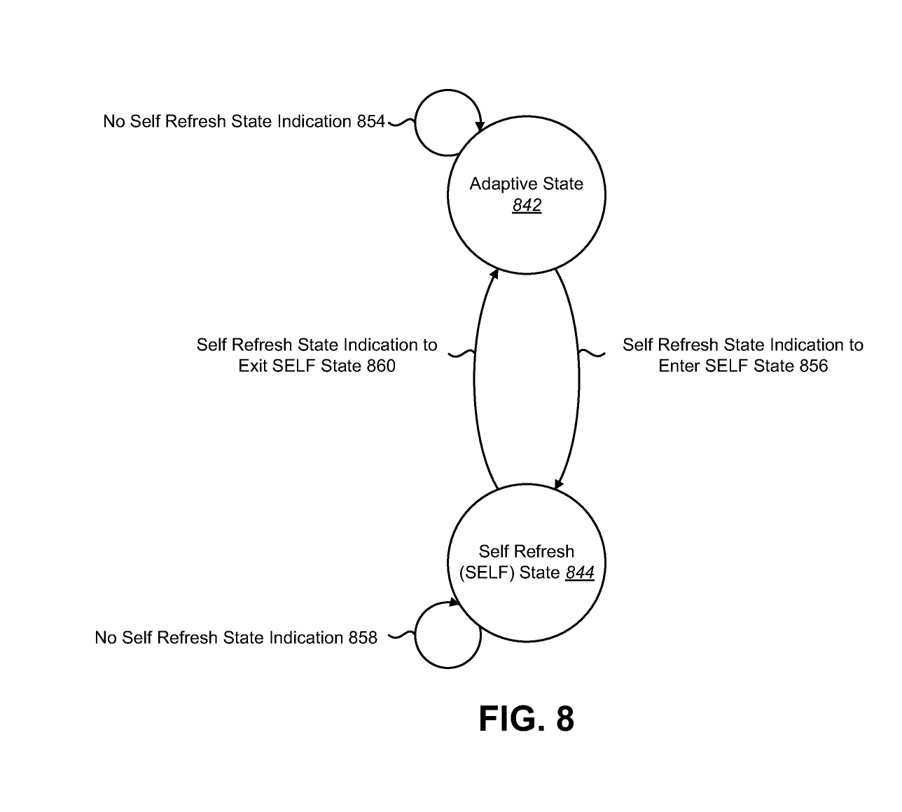

FIG. 8 is a state diagram illustrating an adaptive state 842 and a SELF state 844 that the electronic device 102 may operate according to. In some configurations (as illustrated in FIG. 8), the electronic device 102 may only operate according to either an adaptive state 842 or a SELF state 844. In other configurations, the electronic device 102 may operate according to one or more additional states.

In some configurations, the state determination module 746 may control the transitions between the various states. The state determination module 746 may determine if a state transition will occur following each image 712. It is noted that a possible state transition may occur following each image. For example, the state determination module 746 may cause the refresh module 740 to transition from operating in the SELF state 844 to operation in the adaptive state 842 following a first image 712 when the state determination module 746 obtains a self refresh state indication (to exit the SELF state 844, for example). It should be noted that an indication 750 (e.g., self refresh state indication) may be an indication to enter a particular state or may be an indication to exit a particular state. For example, a first self refresh state indication 856 may be an indication to enter the SELF state 844 and a second self refresh state indication 860 may be an indication to exit the SELF state 844. It should be noted that although the terms “first” and “second” are used to distinguish types of self refresh state indications, the first and second self refresh state indications may occur in any order and may not necessarily occur in any particular sequence.

The refresh module 740 may operate in the adaptive state 842 until the state determination module 746 determines that the refresh module 740 should operate in a different state. When operating in the adaptive state 842, the state determination module 746 may monitor the indications 750 for a self refresh state indication (to enter the SELF state 844, for example). If a self refresh state indication has not been obtained, the state determination module 746 may direct the refresh module 740 to continue 854 operating according to the adaptive state 842. It should be noted that the electronic device 102 may output pixel data 718 based on the passed through images 712 during the adaptive state 842. If a self refresh state indication has been obtained, the state determination module 746 may direct the refresh module 740 to transition 856 from operating according to the adaptive state 842 to operating according to the SELF state 844.

The refresh module 740 may operate in the SELF state 844 until the state determination module 746 determines that that the refresh module 740 should operate in a different state. When operating in the SELF state 844, the state determination module 746 may monitor the indications 750 for a self refresh state indication (to exit the SELF state 844, for example). If a self refresh state indication has not been obtained, the state determination module 746 may direct the refresh module 740 to continue 858 operating according to the SELF state 844. It should be noted that the electronic device 102 may output pixel data 718 based on the frame memory 726 during the SELF state 844 (until a signal (e.g., self refresh state indication) is sent to exit the SELF state 844, for example). If a self refresh state indication has been obtained, the state determination module 746 may direct the refresh module 740 to transition 860 from operating according to the SELF state 844 to operating according to the adaptive state 842.

It is noted that in some configurations, the adaptive state 842 may be a change adaptive state (discussed below). Additionally or alternatively, the adaptive state 842 may be a motion adaptive state (discussed below).

FIG. 9 is a state diagram illustrating an example of operating states for adapting refresh behavior on an electronic device 102. In some configurations (as illustrated in FIG. 9), the electronic device 102 may operate according to a FULL state 962, a SELF state 944, a MARC state 982 or a CARC state 990. In some configurations (not shown), the electronic device 102 may operate according to additional or alternative states.

In some configurations, the state determination module 746 may control the transitions between the various states. The state determination module 746 may determine if a state transition will occur. It is noted that a possible state transition may occur following each frame. For example, the state determination module 746 may cause the refresh module 740 to transition from operating according to the SELF state 944 to operation according to the CARC state 990 following a first image 712 when the state determination module 746 obtains a self refresh state indication to exit the SELF state 944. It should be noted that an indication (e.g., self refresh state indication, full refresh indication) may be an indication to enter a particular state or may be an indication to exit a particular state.

The refresh module 740 may operate in the CARC state 990 until the state determination module 746 determines that the refresh module 740 should operate in a different state. When operating in the CARC state 990, the state determination module 746 may monitor any indications 750 for a self refresh state indication or a full refresh state indication. Additionally, the state determination module 746 may monitor the difference indicator 748 for determining whether the differences between two or more frames exceeds a threshold. In some configurations, the differences between two or more frames may be determined based on a SAD calculation. For example, determining whether the differences between two or more frames exceeds a threshold may comprise determining whether a number of large SAD frames (e.g., frames with large SAD values) exceeds a threshold (five large SAD frames, for example). In some cases, the size of a SAD value may be relative to the image resolution. For example, for an image resolution of 1024×600, a SAD value of 40,000 may be a ‘small’ SAD value. The SAD value may be higher for a high resolution display. It should be noted that a ‘large’ SAD value may be greater than a ‘small’ SAD value.

If none of these conditions occur (self refresh state indication, full refresh state indication or differences between frames that exceeds a threshold) then the state determination module 746 may direct the refresh module 740 to continue 992 operating according to the CARC state 990. If a full refresh state indication (to enter the FULL state 962, for example) is obtained, then the state determination module 746 may direct the refresh module 740 to transition 976 from operating according to the CARC state 990 to operating according to the FULL state 962. If a self refresh state indication (to enter the SELF state 944, for example) is obtained, then the state determination module 746 may direct the refresh module 740 to transition 978 from operating according to the CARC state 990 to operating according to the SELF state 944. If a difference between frames exceeds a threshold (the number of large SAD frames is greater than a threshold, for example), then the state determination module 746 may direct the refresh module 740 to transition 988 from operating according to the CARC state 990 to operating according to the MARC state 982. It is noted that the transition 988 from the CARC state 990 to the MARC state 982 may be an automatic transition (may transition without any user interaction, for example).

While operating in the CARC state 990, the electronic device 102 may monitor at least two frames (e.g., incoming images 112) for differences. The electronic device 102 may detect any change between the at least two incoming frames. In some configurations, a change may be detected based on a SAD calculation. In other configurations, a change may be detected if two frames are not identical (a single pixel value is different, for example). The electronic device 102 may indicate a refresh when any change is detected. For example, indicating a refresh may comprise sending an indicator (e.g., a flag) that indicates that a display should be refreshed. In some configurations, the electronic device 102 may indicate 608 a refresh using the refresh indicator 114 discussed previously with respect to FIG. 1.

The refresh module 740 may operate in the MARC state 982 until the state determination module 746 determines that the refresh module 740 should operate in a different state. When operating in the MARC state 982, the state determination module 746 may monitor any indications 750 for a self refresh state indication or a full refresh state indication. Additionally, the state determination module 746 may monitor the difference indicator 748 for determining whether the differences between two or more frames exceeds a threshold. In some configurations, the differences between two or more frames may be determined based on a SAD calculation. For example, determining whether the differences between two or more frames exceeds a threshold may comprise determining whether a number of SAD zero frames (e.g., frames with a SAD value of zero) exceeds a threshold (five SAD zero frames, for example). If none of these conditions occur (self refresh state indication, full refresh state indication or differences between frames that exceeds a threshold) then the state determination module 746 may direct the refresh module 740 to continue 984 operating according to the MARC state 982. If a full refresh state indication is obtained, then the state determination module 746 may direct the refresh module 740 to transition 972 from operating according to the MARC state 982 to operating according to the FULL state 962. If a self refresh state indication is obtained, then the state determination module 746 may direct the refresh module 740 to transition 978 from operating according to the MARC state 982 to operating according to the SELF state 944. If a difference between frames exceeds a threshold (the number of SAD zero frames is greater than a threshold, for example), then the state determination module 746 may direct the refresh module 740 to transition 986 from operating according to the MARC state 982 to operating according to the CARC state 990. It is noted that the transition 986 from the MARC state 982 to the CARC state 990 may be an automatic transition (may transition without any user interaction, for example).

While operating in the MARC state 982, the electronic device 102 may monitor at least two frames (e.g., incoming frames) for differences. The electronic device 102 may determine a fraction of frames to display based on a measure of difference between the at least two incoming frames. For example, if there is very little change between a first and a fourth frame and more significant changes in a fifth frame, then the electronic device 102 may determine to skip the second frame through the fourth frame and only display the first frame and the fifth frame. Therefore, in one configuration, the first frame may be displayed until it is refreshed with the fifth frame. The electronic device 102 may indicate a refresh based on the fraction of frames. For instance (continuing with the previous example), the electronic device 102 may indicate a refresh for the first frame and for the fifth frame. The remaining frames (the second through fourth frames, for example) may be skipped. In some configurations, indicating a refresh may comprise sending an indicator (e.g., a flag) that indicates that a display should be refreshed. In some configurations, the electronic device 102 may indicate a refresh using the refresh indicator 114 discussed previously with respect to FIG. 1.

The refresh module 740 may operate in the FULL state 962 until the state determination module 746 determines that the refresh module 740 should operate in a different state. When operating in the FULL state 962, the state determination module 746 may monitor any indications 750 for a self refresh state indication. Additionally, the state determination module 746 may monitor the difference indicator 748 for determining whether the differences between two or more frames exceeds a threshold. In some configurations, the differences between two or more frames may be determined based on a SAD calculation. For example, determining whether the differences between two or more frames exceeds a threshold may comprise determining whether a number of small SAD frames (e.g., frames with a small SAD value) exceeds a threshold (five small SAD frames, for example). In some cases (for a display with 1024×600 resolution, for example), a SAD value of 40,000 may be a ‘small’ SAD value. It should be noted that the ‘small’ SAD value may need to be higher for a high resolution display.

If none of these conditions occur (self refresh state indication or differences between frames that exceeds a threshold) then the state determination module 746 may direct the refresh module 740 to continue 964 operating according to the FULL state 962. If a self refresh state indication is obtained, then the state determination module 746 may direct the refresh module 740 to transition 966 from operating according to the FULL state 962 to operating according to the SELF state 944. If a difference between frames exceeds a threshold (the number of small SAD frames is greater than a threshold, for example), then the state determination module 746 may direct the refresh module 740 to transition 974 from operating according to the FULL state 962 to operating according to the CARC state 990. It is noted that the transition 974 from the FULL state 962 to the CARC state 990 may be an automatic transition (may transition without any user interaction, for example).

While operating in the FULL state 962, the electronic device 102 may enable a display to operate at maximum refresh rate. In some configurations, the electronic device 102 may provide an indication to the display to refresh itself at least for each frame obtained. In other configurations, the electronic device 102 may provide the display with indications to refresh each time a refresh indication is obtained. It is noted that in some configurations, the electronic device 102 may continue to provide refresh indications (via refresh indicator 114, for example) to indicate the display to refresh. For these configurations, the electronic device 102 may indicate a refresh for (at least) every frame. In some configurations, the electronic device 102 may indicate a refresh using the refresh indicator 114 discussed previously with respect to FIG. 1.

The refresh module 740 may operate in the SELF state 944 until the state determination module 746 determines that the refresh module 740 should operate in a different state. When operating in the SELF state 944, the state determination module 746 may monitor any indications 750 for a full refresh state indication. Additionally, the state determination module 746 may monitor the difference indicator 748 for determining whether a difference between frames occurs. In some configurations, the difference between frames may be any difference that occurs between an incoming frame and a static frame that may be used for SELF state refreshes. If neither of these conditions occur (full refresh state indication or differences between frames), then the state determination module 746 may direct the refresh module 740 to continue 970 operating according to the SELF state 944. If a full refresh state indication is obtained, then the state determination module 746 may direct the refresh module 740 to transition 968 from operating according to the SELF state 944 to operating according to the FULL state 962. If a self refresh state indication is obtained (to exit the SELF state 944), then the state determination module 746 may direct the refresh module 740 to transition 980 from operating according to the SELF state 944 to operating according to the CARC state 990. In some configurations, operating according to the SELF state 944 comprises setting some or all of the host device (e.g., Graphics Processing Unit (GPU)) to a sleep state.

While operating in the SELF state 944, the electronic device 102 may enable a display to refresh itself from a local memory (e.g., frame memory 726). In some configurations, the electronic device 102 may provide an indication to the display to refresh itself from a local memory. It is noted that in some configurations, the electronic device 102 may continue to provide refresh indications (via refresh indicator 114, for example) to adapt the display behavior of the display while the display is in a self refresh mode (e.g., using a stored frame to refresh).

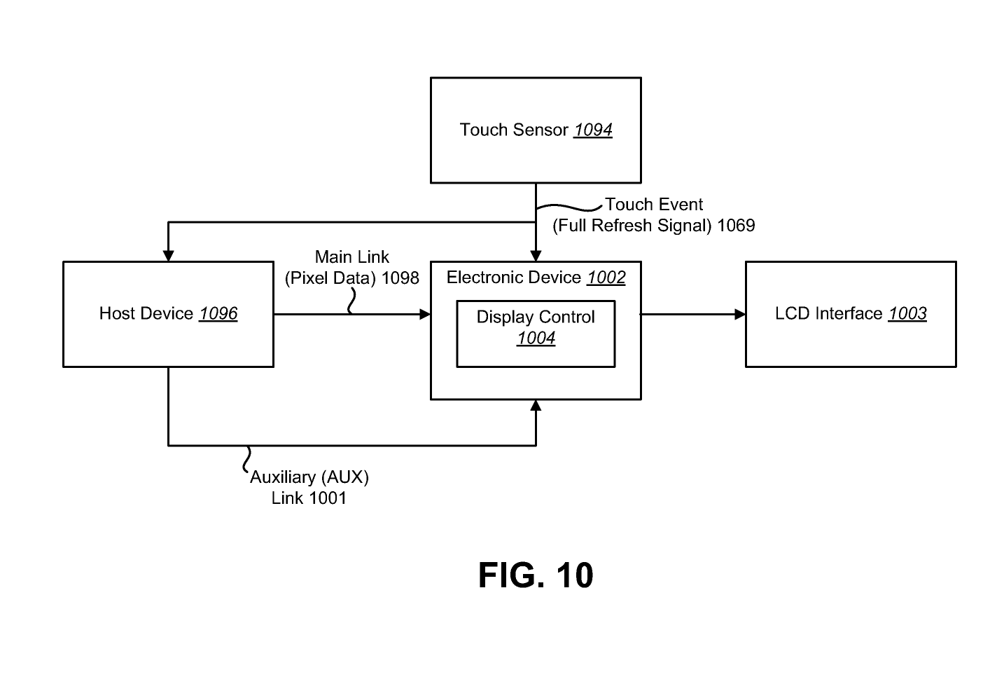

FIG. 10 is a block diagram illustrating yet another more specific example of an electronic device 1002 in which systems and methods for adapting display behavior may be implemented. An electronic device 1002 may control the display behavior of a display (via a Liquid Crystal Display (LCD) interface 1003, for example). The electronic device 1002 may receive various inputs. For example, the electronic device 1002 may receive a main link 1098 and optionally, an auxiliary link 1001 from a host device 1096. The main link 1098 may include pixel data and frame data (e.g., images 712). In some configurations, the main link 1098 may also include auxiliary information (e.g., indications 750). In some configurations, an auxiliary link 1001 may include auxiliary information (e.g., indications 750). The electronic device 1002 may additionally receive auxiliary information (e.g., indications 750) from another device (e.g., touch sensor 1094). In one example, the touch sensor 1094 may send a touch event 1069 comprising a full refresh state indication (e.g., indication 750) directly to the electronic device 1002. In another example, the touch sensor 1094 may send a touch event 1069 comprising a full refresh state indication to the host device 1096 which may indicate the full refresh state indication via the auxiliary link 1001.

The electronic device 1002 may include a display control 1004 for controlling the display behavior (via the LCD interface 1003, for example). For example, the electronic device 1002 may indicate to the display control 1004 (via refresh indicator 124, for example) when the backlight changes and refreshes should occur. The electronic device 1002 may be similar to the electronic device 102 described previously with respect to FIG. 1. The electronic device 1002 may adapt the backlight and refresh behavior of a display using the systems and methods disclosed herein. In some configurations, the electronic device 1002, the touch sensor 1094 and the LCD interface 1003 may be integrated into a single device (e.g., a display, monitor, television, touchscreen, etc.).

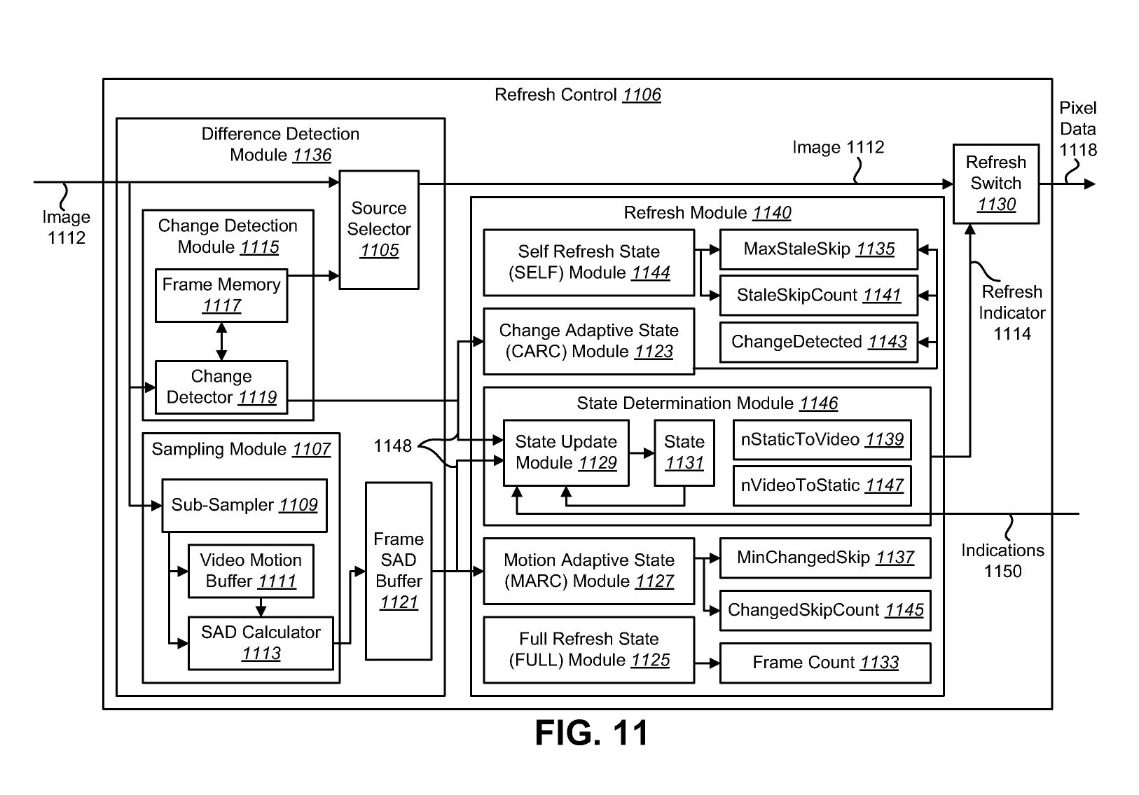

FIG. 11 is a block diagram illustrating a more specific example of a refresh control 1106 in which systems and methods for adapting refresh behavior may be implemented. A refresh control 1106 may include a difference detection module 1136 and a refresh module 1140. The difference detection module 1136 may be similar to the difference detection module 736 and the refresh module 1140 may be similar to the refresh module 740 described previously with respect to FIG. 7.

The difference detection module 1136 may obtain images 1112. The images 1112 may be obtained from a host device as described previously with respect to FIG. 10. Alternatively, the images 1112 may be compensated images 320 obtained from the backlight control as described previously with respect to FIG. 3. The difference detection module 1136 may include a sampling module 1107 and a change detection module 1115. In some configurations, the difference detection module 1136 may include the change detection module 1115 (and not the sampling module 1107). In other configurations, the difference detection module 1136 may include the sampling module 1107 (and not the change detection module 1115).

The difference detection module 1136 may additionally include a source selector 1105. The source selector 1105 may output pixel data 1118 based on the selected source. When the frame memory 1117 is selected, the pixel data 1118 may be one or more static frames (e.g., full frames or sub-sampled frames) that are stored in the frame memory 1117. When the pass through source is selected, the pixel data 1118 may be the obtained images 1112. In some configurations, the source selector 1105 may provide the pixel data 1118 from the frame memory 1117 during the SELF state 1144 and may provide the pixel data 1118 from the pass through images 1112 during the other states (e.g., when the FULL state module 1125, MARC state module 1127 or CARC state module 1123 is operating).

The change detection module 1115 may enable change detection between two (or more) images 1112. The change detection module 1115 may include a change detector 1119 and a frame memory 1117. The change detector 1119 may be similar to the difference detector 738 and the frame memory 1117 may be similar to the frame memory 726 discussed previously with respect to FIG. 7. In some configurations, the change detector 1119 may detect a change by comparing an image 1112 with a previously stored image (stored in frame memory 1117, for example). Following a comparison, the change detection module 1115 may replace the previously stored image with the image 1112 (in the frame memory 1117, for example). In some cases, the frame memory 1117 may enable self refresh functionality. For example, the source selector 1105 may select an image for display from either the incoming images 1112 from an external source (e.g., the host device or compensated image 320 from the backlight control 308) or from the frame memory 1117. Thus, the combination of the source selector 1105 and the frame memory 1117 may allow a host device to enter a sleep state while refreshing from a static frame stored in the frame memory 1117 (e.g., local memory in the electronic device 102). It is noted that this self refresh functionality may be provided with a display device that does not itself provide self refresh abilities.

The sampling module 1107 may enable change detection based on a SAD calculation with respect to two (or more) images 1112. The sampling module 1107 may include a sub-sampler 1109, a video motion buffer 1111 and a SAD calculator 1113. The sub-sampler 1109 may subsample each image 1112 and the SAD calculator 1113 may compare (by computing the SAD, for example) the subsampled frame with a previously subsampled frame. In some configurations, previously subsampled frames may be stored in the video motion buffer 1111. Comparing frames based on SAD may be beneficial for quantizing the amount of change between two frames. It should be noted that in some configurations, difference determination may be based exclusively on either the sampling module 1107 or the change detection module 1115. In other configurations (as illustrated in FIG. 11, for example) a combination of sampling module 1107 and the change detection module 1115 may be used. For instance, the change detection module 1115 may be used when operating according to the CARC state 1123 and the sampling module 1107 may be used when operating according to the MARC state 1127. The difference detection module 1136 may additionally include a frame SAD buffer 1121 for dynamically selecting threshold values based on historical SAD values.

The refresh module 1140 may be similar to the refresh module 740 discussed previously with respect to FIG. 7. The refresh module 1140 may include a CARC state 1123, a FULL state 1125, a MARC state 1127 and a SELF state 1144. The CARC state 1123 may be similar to one or more of the adaptive state 742 and the CARC state (e.g., CARC state 990) described above. The FULL state 1125 may be similar to one or more of the FULL state (e.g., FULL state 962) described above. The MARC state 1127 may be similar to one or more of the adaptive state 742 and the MARC state (e.g., MARC state 982) described above. The SELF state 1144 may be similar to one or more of the SELF states (e.g., SELF state 744, 944) described above.

The refresh module 1140 may additionally include a state determination module 1146. The state determination module 1146 may be similar to the state determination module 746 discussed previously with respect to FIG. 7. The state determination module 1146 may include a state update module 1129 for controlling (e.g., directing) transitions between states.

The state update module 1129 may control transitions between states based on various variables. In some configurations, the various variables may be stored in memory. Examples of variables include State 1131 (indicating the current operating state), FrameCount 1133 (indicating a number frame since a given start point), MaxStaleSkip 1135 (indicating a maximum frames that may be skipped so that a display may be refreshed before exceeding the maximum hold time of the display), MinChangedSkip 1137, nStaticToVideo 1139, StaleSkipCount 1141, ChangeDetected 1143, ChangedSkipCount 1145, nVideoToStatic 1147, etc. The state update module 1129 may obtain one or more difference indicators 1148 from the difference detection module 1136 and one or more indications 1150 (e.g., from an auxiliary link 1001, touch event 1069, etc.). The state update module 1129 may control the operation of each state and the transitions between the states based on the indications and one or more variables. It is noted that the state update module 1129 may use the state 1131 to indicate the current operating state and determine subsequent operating states. An nStaticToVideo 1139 variable and an nVideoToStatic 1147 variable may be used for controlling the transitions between the video (MARC) state and the static (CARC) state. For example, when in the CARC state and the number of recent frames with change exceeds the nStaticToVideo 1139 variable, the state is changed to the MARC state. When in the MARC state and the number of consecutive frames with no change (e.g., static) exceeds the nVideoToStatic 1147 variable, the state is changed to the CARC state.

The refresh module 1140 may provide a refresh indicator 1114 to indicate a refresh to a refresh switch 1130. In some configurations, the refresh indicator 1114 may include a RefreshFlag value (e.g., TRUE or FALSE) for indicating a refresh. The refresh switch 1130 may include an output that includes one or more frames (e.g., pixel data 1118).

Examples of how various state variables may be used for operation in each state are provided as follows. In some configurations, the Full Refresh (FULL) state 1125 may obtain incoming frames from a main link. In the FULL state 1125, the refresh indicator 1114 (e.g., a refresh flag) may always indicate that a refresh should be made (for example, a refresh flag may always be set as 1 (e.g., high, TRUE, etc.)). In some configurations, the FrameCount 1133 (for counting frames, for example) may be incremented for each frame and may be used to determine when to exit this state.

In some configurations, the Self Refresh (SELF) state 1144 may obtain a frame from the frame memory 1117. Upon entry into the SELF state 1144, a frame from a main link may be stored in the frame memory 1117. In one configuration, the SELF state 1144 may include a variable that indicates the number of refresh cycles that are skipped (e.g., the StaleSkipCount 1141). If the StaleSkipCount 1141 is greater than or equal to a threshold (e.g., a MaxStateSkip 1135) then a refresh is indicated 1114 (e.g., refresh flag=TRUE) and the StaleSkipCount 1141 is reset (e.g., StaleSkipCount=0). However, if the StaleSkipCount 1141 is less than a threshold (e.g., the MaxStateSkip 1135) then the StaleSkipCount 1141 is incremented (e.g., StaleSkipCount++) and a refresh is not indicated (e.g., refresh flag=False).

In some configurations, the Motion Adaptive (MARC) state 1127 may obtain incoming frames from a main link. At the beginning of each frame, a Frame SAD value may be set to zero. Each line of the frame data may be subsampled to a low resolution and a SAD calculation may be updated. At the end of each frame, the Frame SAD value may be written to a buffer (e.g., video motion buffer 1111). In the MARC state 1127, the ChangedSkipCount 1145 may indicate a number of frames to skip and the MinChangedSkip 1137 may indicate a skip threshold based on SAD history. At the beginning of each frame, the present value of the MinChangedSkip 1137 and the present value of the ChangedSkipCount 1145 are used to control the refresh indicator 1114 (e.g., refresh flag). If the ChangedSkipCount 1145 is greater than or equal to a threshold (e.g., MinChangedSkip 1137), then a refresh is indicated 1114 (e.g., RefreshFlag=TRUE) and the ChangedSkipCount 1145 is reset (e.g., ChangedSkipCount=0.). However, if the ChangedSkipCount 1145 is less than a threshold (e.g., MinChangedSkip 1137), then the ChangedSkipCount 1145 is incremented (e.g., ChangedSkipCount++) and a refresh is not indicated (e.g., RefreshFlag=FALSE). It is noted that the value of MinChangedSkip 1137 may be based on recent SAD history.

In one configuration, the change adaptive (CARC) state 1123 may obtain incoming frames from a main link. At the beginning of each frame, the present value of ChangeDetected 1143 as well as StaleSkipCount 1141 and the MaxStateSkip 1135 may be used to control the refresh indicator 1114 (e.g., RefreshFlag variable). In the CARC state 1123, the ChangeDetected 1143 variable may indicate whether a change (between two frames, for example) has been detected. If a change has been detected (e.g., ChangeDetected=TRUE), then a refresh is indicated (e.g., RefreshFlag=TRUE) and the StaleSkipCount 1141 is reset (e.g., StaleSkipCount=0). However, if a change is not detected (e.g., ChangeDetected=FALSE) but the StaleSkipCount 1141 is greater than or equal to a threshold (e.g., MaxStateSkip 1135) then a refresh is indicated 1114 (e.g., RefreshFlag=TRUE) and the StaleSkipCount 1141 is reset (e.g., StaleSkipCount=0). However, if a change is not detected (e.g., ChangeDetected=FALSE) and the StaleSkipCount 1141 is less than a threshold (e.g., MaxStateSkip 1135), then a refresh is not indicated (e.g., RefreshFlag=FALSE) and the StaleSkipCount 1141 is incremented (e.g., StaleSkipCount++).

As described above, several state variables may be used to control the operations within each state. In some configurations, state variables may also be used to control the transitions between the individual states.

In some configurations, one or more of the electronic device 102 and refresh control 1106 may be integrated into a single device, such as a display, monitor, television, touchscreen, etc. In other configurations, one or more of the electronic device 102 and refresh control 1106 may be included within a host device. In some cases, the source selector 1105 may be external to the electronic device 102.

FIG. 12 is a block diagram illustrating an even more specific example of an electronic device 1202 in which systems and methods for adapting display behavior may be implemented. In the configuration depicted in FIG. 12, multiple systems and methods for adapting display behavior may be included. For example, the electronic device 1202 may include a display control 1204 that may include systems and methods to perform display self refresh, still image reduced refresh control, motion adaptive refresh control and content based backlight dimming. In this configuration, a video rate module 1271 and a still image detection module 1273 may be separate. The video rate module 1271 may use a comparatively small memory and may be combined with a backlight control 1208. The still image detection module 1273 may use a frame memory 1217 and may be combined with a display self refresh (described below).

The electronic device 1202 may include systems and methods to perform display self refresh control. For example, the electronic device 1202 may include a still image detection module 1273. The still image detection module 1273 may include a frame memory 1217 and a change detector 1219. The change detector 1219 may obtain an indication 1250 that the electronic device 1202 should enter a self refresh state (e.g., SELF state 944 as described in FIG. 9). For example, a host may send the self refresh indication 1250 to the electronic device 1202. In the configuration depicted in FIG. 12, a change detector 1219 may obtain the indication 1250. Upon receiving the indication 1250, the change detector 1219 may transition to a SELF state. While in the SELF state, the electronic device 1202 may use an image 1212 stored in a frame memory 1217 to refresh the display. As described above with respect to FIG. 9, it is noted that when the electronic device 1202 is in a SELF state, the electronic device 1202 may continue to provide refresh indicators 1214a, which may result in a low frequency of display refreshes. In one configuration, the host may provide a specified rate of refresh (e.g., 0.5 Hz) in the indication 1250 while the electronic device 1202 is operating in the SELF state. In another configuration, the refresh rate may be determined by the electronic device 1202.

The electronic device 1202 may also include systems and methods to perform still image reduced refresh control (e.g., still detection control). For example, the change detector 1219 may obtain images 1212 that may be stored in the frame memory 1217. By comparing the stored images, the change detector 1219 may determine that the incoming images 1212 may represent a still image. If the change detector 1219 does not detect a change in the images 1212, then the electronic device 1202 may enter a still image state. As with the display self refresh, when in the still image state, the electronic device 1202 may use an image 1212 stored in the frame memory 1217 to refresh the display. In one configuration, a refresh indicator 1214a may be provided by the change detector 1219 to the refresh switch 1230. When the refresh indicator 1214a indicates to the refresh switch 1230 that a display refresh should occur, the refresh switch 1230 may permit the compensated image 1220 to pass as the pixel data 1218. It is noted that when the electronic device 1202 may be in the still image state, the backlight level 1216 may be held constant and the display may be refreshed at a low rate (e.g., 0.5 Hz). In one configuration, the electronic device 1202 may wait until several unchanged images 1212 have been detected to allow the backlight level 1216 to stabilize.

The electronic device 1202 may further include systems and methods to perform motion adaptive refresh control (e.g., adaptive refresh control). For example, the display control 1204 may include a video rate module 1271. The video rate module 1271 may include a sampling module 1207, a frame SAD buffer 1221 and a MARC state module 1227. The sampling module 1207 may be similar to the sampling module 1107, the frame SAD buffer 1221 may be similar to the frame SAD buffer 1121 and the MARC state module 1227 may be similar to the MARC state module 1127 described previously with respect to FIG. 11. Additionally, the sampling module 1207 may include a sub-sampler 1209, a video motion buffer 1211 and an SAD calculator 1213. The sub-sampler 1209 may be similar to the sub-sampler 1109, the video motion buffer 1211 may be similar to the video motion buffer 1111 and the SAD calculator 1213 may be similar to the SAD calculator 1113 described previously with respect to FIG. 11. As described above, the MARC state module 1227 may determine a fraction of frames to display based on a measure of difference between the incoming images 1212. The MARC state module 1227 may determine a refresh indicator 1214b that may correspond to a fraction of the incoming images 1212. In the configuration depicted in FIG. 12, the refresh indicator 1214b determined by the MARC state module 1227 may be used to trigger the backlight level determination module 1222 and a refresh switch 1230. When the refresh indicator 1214b indicates to the refresh switch 1230 a display refresh should occur, the refresh switch 1230 may permit the compensated image 1220 to pass as the pixel data 1218.

The electronic device 1202 may additionally include systems and methods to perform content based backlight dimming. For example, the display control 1204 may include a backlight control 1208. The backlight control 1208 may include a backlight level determination module 1222 and an image compensation module 1210. The backlight level determination module 1222 may analyze the image 1212 to determine a backlight level 1216. The image compensation module 1210 may obtain the image 1212 and may determine a compensated image 1220 using the backlight level 1216. The backlight level determination module 1222 may also respond to a refresh indicator 1214b. For example, the backlight level determination module 1222 may wait to obtain the refresh indicator 1214b before determining a backlight level 1216.

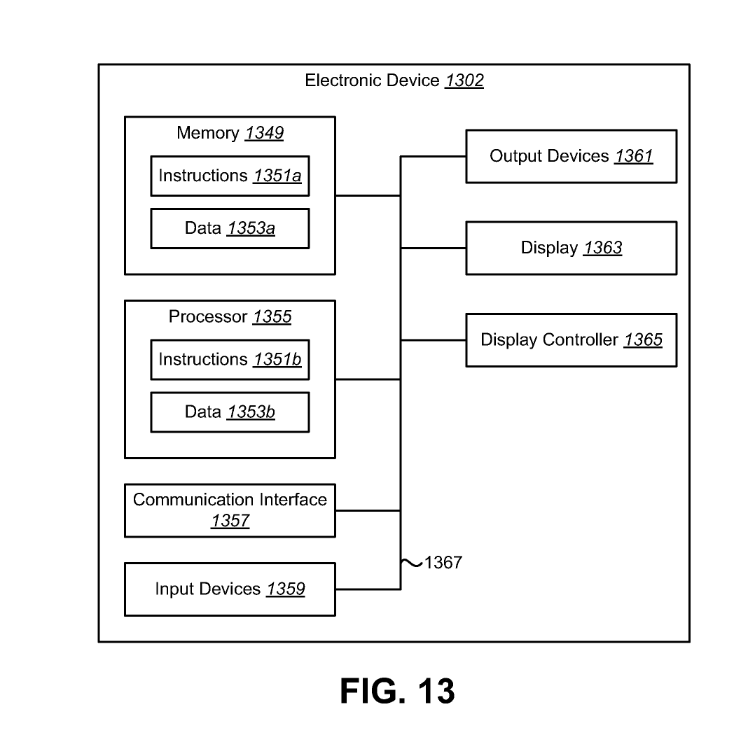

FIG. 13 illustrates various components that may be utilized in an electronic device 1302. The electronic device 1302 may be implemented as one or more of the electronic devices (e.g., electronic devices 102, 302, 502, 702, 1002, 1202) described previously.

The electronic device 1302 includes a processor 1355 that controls operation of the electronic device 1302. The processor 1355 may also be referred to as a CPU. Memory 1349, which may include both read-only memory (ROM), random access memory (RAM) or any type of device that may store information, provides instructions 1351a (e.g., executable instructions) and data 1353a to the processor 1355. A portion of the memory 1349 may also include non-volatile random access memory (NVRAM). The memory 1349 may be in electronic communication with the processor 1355.

Instructions 1351b and data 1353b may also reside in the processor 1355. Instructions 1351b and/or data 1353b loaded into the processor 1355 may also include instructions 1351a and/or data 1353a from memory 1349 that were loaded for execution or processing by the processor 1355. The instructions 1351b may be executed by the processor 1355 to implement the systems and methods disclosed herein.

The electronic device 1302 may include one or more communication interfaces 1357 for communicating with other electronic devices. The communication interfaces 1357 may be based on wired communication technology, wireless communication technology, or both. Examples of communication interfaces 1357 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3rd Generation Partnership Project (3GPP) specifications and so forth.

The electronic device 1302 may include one or more output devices 1361 and one or more input devices 1359. Examples of output devices 1361 include a speaker, printer, etc. One type of output device that may be included in an electronic device 1302 is a display device 1363. Display devices 1363 used with configurations disclosed herein may utilize any suitable image projection technology, such as a cathode ray tube (CRT), liquid crystal display (LCD), light-emitting diode (LED), gas plasma, electroluminescence or the like. A display controller 1365 may be provided for converting data stored in the memory 1349 into text, graphics, and/or moving images (as appropriate) shown on the display 1363. Examples of input devices 1359 include a keyboard, mouse, microphone, remote control device, button, joystick, trackball, touchpad, touchscreen, lightpen, etc.

The various components of the electronic device 1302 are coupled together by a bus system 1367, which may include a power bus, a control signal bus and a status signal bus, in addition to a data bus. However, for the sake of clarity, the various buses are illustrated in FIG. 13 as the bus system 1367. The electronic device 1302 illustrated in FIG. 13 is a functional block diagram rather than a listing of specific components.

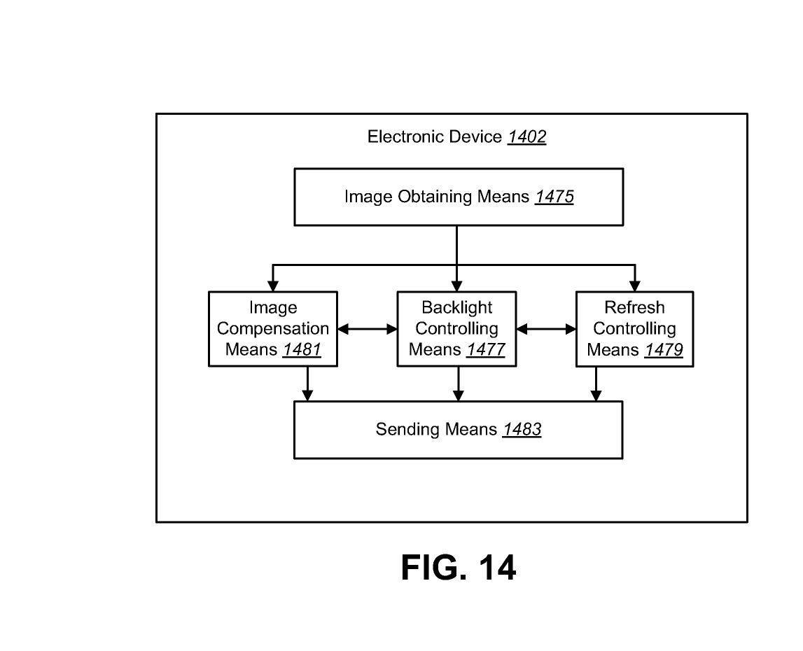

FIG. 14 is a block diagram illustrating another example of an electronic device 1402 in which systems and methods for adapting display behavior may be implemented. The electronic device 1402 includes image obtaining means 1475, image compensation means 1481, backlight controlling means 1477, refresh controlling means 1479 and sending means 1483. The electronic device 1402 with the included means 1475, 1481, 1477, 1479, 1483 may be configured to perform one or more of the functions described in connection with FIG. 2, FIG. 4 and FIG. 6 above. FIG. 13 above illustrates one example of a concrete apparatus structure of FIG. 14. Other various structures may be implemented to realize one or more of the functions of FIG. 2, FIG. 4 and FIG. 6.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for adapting display behavior on an electronic device, comprising:
obtaining an image;
determining a backlight level based on the image;
determining a compensated image based on the image and the backlight level;
determining a refresh indicator based on the image;
determining pixel data based on the backlight level, the compensated image and the refresh indicator; and
sending the pixel data, the refresh indicator and the backlight level.

2. The method of claim 1, wherein determining the refresh indicator is based on the backlight level and the compensated image.

3. The method of claim 2, further comprising delaying sending the backlight level based on the refresh indicator.

4. The method of claim 2, further comprising sending the backlight level based on a fixed rate of change.

5. The method of claim 1, wherein determining the backlight level is based on the refresh indicator.

6. The method of claim 5, wherein the refresh indicator comprises a refresh flag, and wherein determining the backlight level and determining the compensated image occurs when the refresh flag is true.

7. The method of claim 1, wherein determining the refresh indicator comprises:
comparing the image to a stored image in a frame memory; and
determining the refresh indicator based on a change in the image and the stored image.

8. The method of claim 1, wherein determining the refresh indicator is based on at least one of a group consisting of an adaptive refresh control, a self refresh control and a still detection control.

9. The method of claim 1, wherein the backlight level is less than maximum.

10. The method of claim 9, further comprising maintaining image brightness by adjusting the compensated image.

11. The method of claim 1, wherein determining a refresh indicator comprises:
comparing the image to a stored image in a frame memory; and
determining the refresh indicator based on a change in the image and the stored image.

12. An electronic device configured for adapting display behavior, comprising:
a processor;
memory in electronic communication with the processor, wherein instructions stored in
the memory are executable to:
obtain an image;
determine a backlight level based on the image;
determine a compensated image based on the image and the backlight level;
determine a refresh indicator based on the image;
determine pixel data based on the backlight level, the compensated image and the refresh indicator; and
send the pixel data, the refresh indicator and the backlight level.

13. The electronic device of claim 12, wherein determining the refresh indicator is based on the backlight level and the compensated image.

14. The electronic device of claim 13, further comprising delaying sending the backlight level based on the refresh indicator.

15. The electronic device of claim 13, further comprising sending the backlight level based on a fixed rate of change.

16. The electronic device of claim 12, wherein determining the backlight level is based on the refresh indicator.

17. The electronic device of claim 16, wherein the refresh indicator comprises a refresh flag, and wherein determining the backlight level and determining the compensated image occurs when the refresh flag is true.

18. The electronic device of claim 12, wherein determining the refresh indicator comprises:
comparing the image to a stored image in a frame memory; and
determining the refresh indicator based on a change in the image and the stored image.

19. The electronic device of claim 12, wherein determining the refresh indicator is based on at least one of a group consisting of an adaptive refresh control, a self refresh control and a still detection control.

20. The electronic device of claim 12, wherein the backlight level is less than maximum.

21. The electronic device of claim 20, further comprising maintaining image brightness by adjusting the compensated image.

22. The electronic device of claim 12, wherein determining a refresh indicator comprises:
comparing the image to a stored image in a frame memory; and
determining the refresh indicator based on a change in the image and the stored image.
